(19) United States
(12) Patent Application Publication
(10) Pub. No.: US 2026/0262022 A1
(43) Pub. Date: Sep. 3, 2026

(54) SYNCHRONIZATION SIGNAL BLOCK WAVEFORMS

(71) Applicant: QUALCOMM Incorporated, San Diego, CA (US)

(72) Inventors: Chinmay Shankar VAZE, San Diego, CA (US); Yuanning YU, Santa Clara, CA (US); Supratik BHATTACHARJEE, San Diego, CA (US)

(21) Appl. No.: 19/467,581

(22) Filed: Feb. 2, 2026

Related U.S. Application Data
(60) Provisional application No. 63/758,945, filed on Feb. 14, 2025.

(51) Int. Cl. H04W 72/0446; H04W 72/0453; H04W 72/30

(52) U.S. Cl. CPC H04W 72/0446; H04W 72/0453; H04W 72/30

(57) ABSTRACT

Certain aspects of the present disclosure provide techniques for wireless communications. An example method (e.g., performed by a user equipment (UE)) includes identifying a synchronization signal block (SSB) in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a machine learning (ML) model configured to detect SSBs; and communicating with a network entity based at least in part on the SSB.

### CROSS REFERENCE TO RELATED APPLICATION(S)

The present Application for Patent claims priority to and benefit of U.S. Provisional Patent Application No. 63/758,945, filed Feb. 14, 2025, which is hereby expressly incorporated by reference herein in its entirety.

### INTRODUCTION

### Field of the Disclosure

Aspects of the present disclosure relate to wireless communications, and more particularly, to techniques for synchronization signal scanning.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In certain wireless communications systems, a user equipment (UE) may scan for certain broadcast signals to establish a communication link with a network entity (e.g., a base station). For example, the UE may perform a full frequency scan across an entire frequency bandwidth that is available for synchronization signals (e.g., one or more synchronization signal blocks (SSBs)). The full frequency scan or other scanning techniques may consume non-trivial amounts of time and power to detect a synchronization signal. Thus, the frequency scanning and the accuracy thereof can affect the latency and/or the power consumption associated with establishing a communication link between a UE and a network entity.

Aspects described herein provide techniques for artificial intelligence (AI)-based synchronization signal scanning as well as techniques for training machine learning (ML) models (e.g., AI model(s)) used for such synchronization signal scanning. In some cases, specific patterns of SSBs may be better configured for detection by an ML model via the AI-based synchronization signal scanning, which may not be possible using non-AI techniques. For example, using non-AI techniques, a UE may miss detection of SSBs under certain conditions (e.g., noisy conditions, such that the SSB cannot be detected or is hard to detect). That is, some SSB patterns may be harder to detect under certain conditions. For example, an SSB pattern may be similar to other types of communications that may occur. As such, a received waveform similar to an SSB pattern may be falsely detected as an SSB, such as under noisy conditions.

Accordingly, an ML model may be trained and/or configured to detect certain features of an SSB, such as a shape of the SSB. For example, the shape of the SSB may correspond to a pattern of resources occupied by the SSB. That is, the SSB may occupy a first set of time-frequency resources (e.g., for synchronization signaling and/or system information) and may not occupy a second set of time-frequency resources (e.g., empty time-frequency resources and/or no transmission regions), such that the first set of time-frequency resources and the second set of time-frequency resources form the pattern. Accordingly, the pattern may enable a UE to detect the SSB (e.g., based on the ML model). The AI-based synchronization signal scanning may enable improved accuracy (e.g., lower miss detections and/or false alarms) with respect to detecting an SSB in a pre-scan. The AI-based synchronization signal scanning described herein may reduce the scan time with respect to a full frequency scan and/or other scanning techniques.

Certain aspects provide a method for wireless communications by a user equipment (UE). The method includes identifying a synchronization signal block (SSB) in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a machine learning (ML) model configured to detect SSBs; and communicating with a network entity based at least in part on the SSB.

Certain aspects provide a method for wireless communications by a network entity. The method includes transmitting a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model, at a UE, configured to detect SSBs; and communicating with the UE based at least in part on the SSB.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 illustrates an example synchronization signal block (SSB) in time and frequency domains.

FIG. 6 illustrates an example artificial intelligence (AI) architecture that may be used for AI-enhanced wireless communications.

FIG. 7 illustrates an example AI architecture of a first wireless device that is in communication with a second wireless device.

FIG. 8 illustrates an example artificial neural network.

FIG. 9 illustrates example operations for performing an SSB pre-scan by a UE.

FIG. 10 illustrates example operations for performing the SSB pre-scan as described herein with respect to FIG. 9.

FIG. 11 illustrates an example convolutional neural network that is trained to detect an SSB.

FIG. 12 illustrates example operations for training a machine learning model to detect an SSB.

FIG. 13 illustrates example scan times for an AI-based SSB scanning technique and a full frequency scan technique.

FIGS. 14A and 14B depict example spectral energy images for detecting an SSB.

FIG. 15 depicts an example SSB in time and frequency domains.

FIG. 16 depicts an example SSB in time and frequency domains.

FIG. 17 depicts an example SSB in time and frequency domains.

FIG. 18 depicts an example SSB in time and frequency domains.

FIG. 19 depicts a process flow for communications in a system between UE and a network entity.

FIG. 20 depicts a method for wireless communications.

FIG. 21 depicts another method for wireless communications.

FIG. 22 depicts aspects of an example communications device.

FIG. 23 depicts aspects of an example communications device.

### DETAILED DESCRIPTION

Aspects of the present disclosure provide apparatuses, methods, processing systems, and computer-readable mediums for artificial intelligence (AI)-based synchronization signal scanning based on one or more synchronization signal block (SSB) waveform shapes (e.g., patterns).

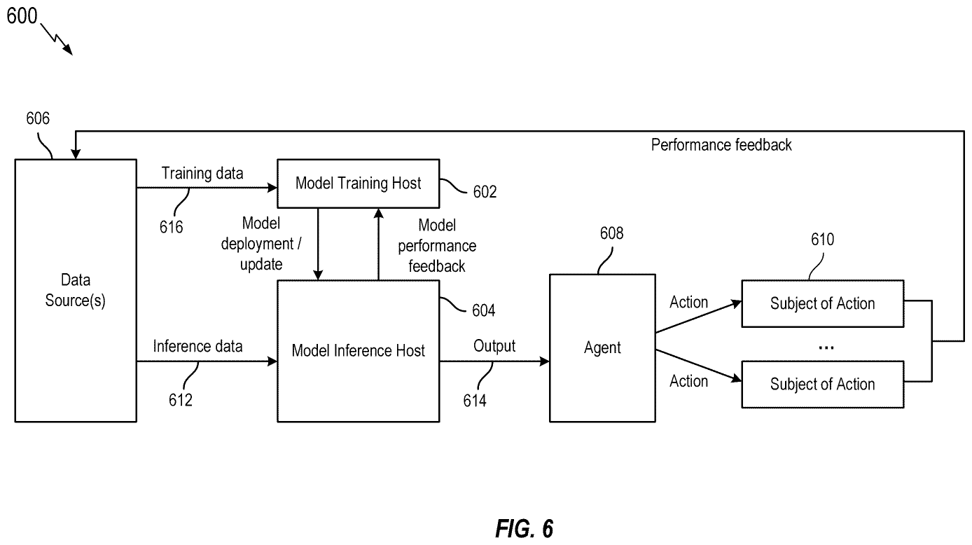

In certain wireless communications systems (e.g., 5G New Radio systems and/or future wireless communications systems), a user equipment (UE) may scan for certain broadcast signals (e.g., synchronization signals) to establish a communication link with a network entity (e.g., a base station). For example, during initial cell acquisition, a UE may scan certain frequency resources for broadcast signals that carry synchronization information, such as an SSB, as further described herein with respect to FIG. 6. SSBs may allow for UEs to acquire wireless communications service from a network entity. For example, an SSB may include at least a primary synchronization signal (PSS), a secondary synchronization signal (SSS), and a physical broadcast channel (PBCH). UEs may be expected to monitor for and detect SSB(s) to acquire timing, frequency, and other critical information for cells (e.g., of a network entity) to enable cell acquisition and/or camping on the cells. The PSS, SSS, and PBCH may include known sequences (e.g., preconfigured and/or predefined sequences, such as defined in wireless communications standards, that are known at the UEs), which may be transmitted by network entities periodically. For example, the broadcast signals may be transmitted with a specific periodicity, for example, every 5 milliseconds (ms) to 160 ms.

Technical problems for scanning synchronization signals include, for example, impacts to the time, accuracy, and/or the power used to perform the synchronization signal scanning. As a UE may not have information regarding the frequency location of the broadcast signals and when the broadcast signals will be transmitted, the UE may scan through multiple frequency bandwidths to detect an SSB, for example, through a full frequency scan across the entire frequency bandwidth that is available for synchronization signals. As an example, the UE may perform a full frequency scan when the device switches out of an offline mode, such as a flight-mode. The offline mode involves a non-connected state where the UE refrains from transmitting radio frequency signals. The full frequency scan may consume non-trivial amounts of time and power to detect an SSB.

In some cases, the UE may perform a spectral energy correlation technique in order to reduce the latency in searching for the SSB. However, such a spectral energy correlation technique can provide a false SSB detection under certain conditions (e.g., false alarms), and hence, in response to a false detection, the UE may search for an SSB where no SSB is being transmitted. Additionally or alternatively, the spectral energy correlation technique may miss detection of SSBs under certain conditions (e.g., noisy conditions, such that the SSB cannot be detected or is hard to detect). Thus, the frequency scanning and the accuracy of such scanning can affect the latency and/or the power consumption associated with establishing a communication link between a UE and a network entity.

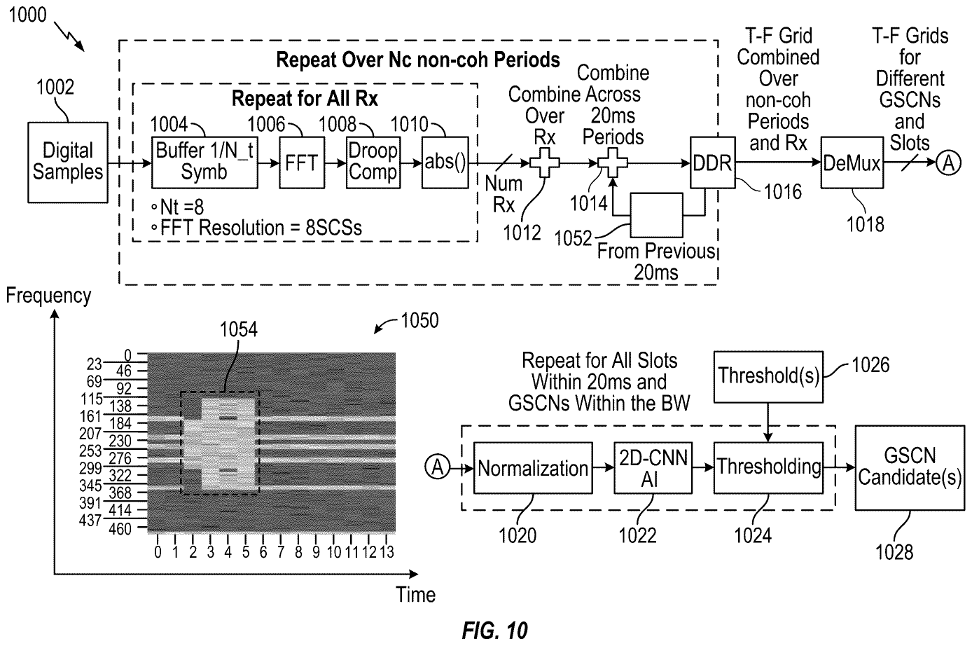

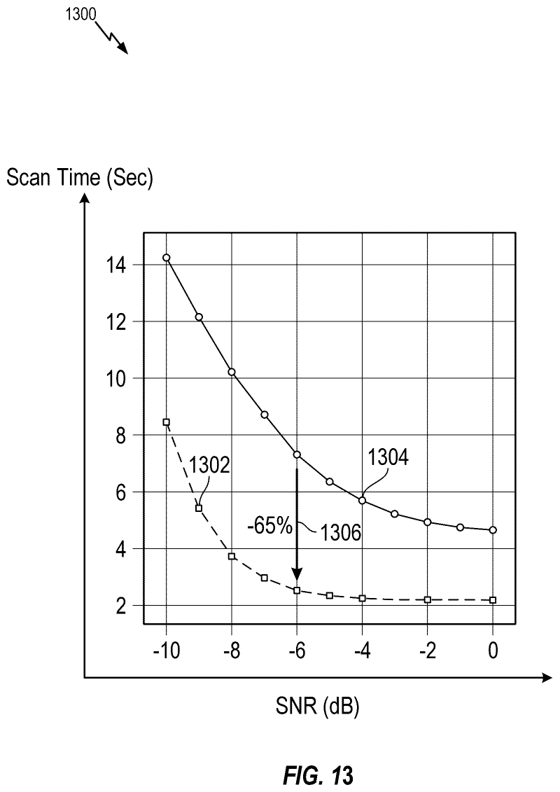

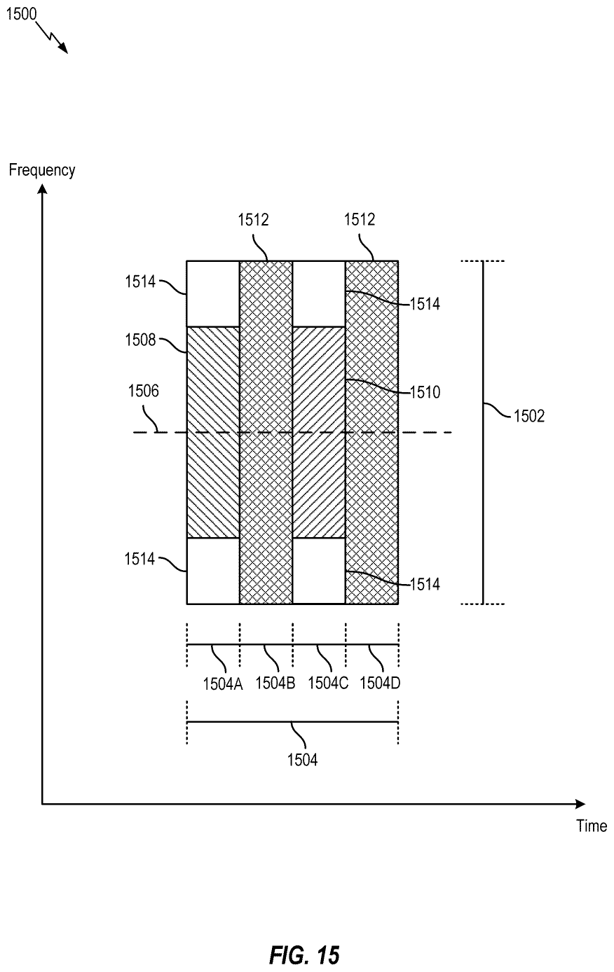

Aspects described herein overcome the aforementioned technical problem(s) by providing techniques for AI-based synchronization signal scanning as well as techniques for training machine learning (ML) model(s) (e.g., AI model(s)) used for such synchronization signal scanning. More specifically, an ML model (e.g., a neural network) may be trained to detect an SSB in a spectral energy image (e.g., a spectrogram or a matrix of values indicative of spectral energy over time) representative of a frequency bandwidth monitored over a specific duration (e.g., 20 ms), for example, as further described herein with respect to FIG. 13. As an example, a UE may perform a synchronization signal pre-scan that identifies candidate frequencies and/or occasions in which SSB(s) can be received. The UE may compress samples of a frequency bandwidth monitored over the duration into the spectral energy image. The UE may provide the spectral energy image to an ML model, and the ML model may output a probability of whether an SSB is detected in the spectral energy image, as further described herein with respect to FIGS. 10-12, based on a shape (e.g., pattern) of the SSB as further depicted and described with respect to FIGS. 15-18. In cases where an SSB is detected in a particular frequency bandwidth, the UE may perform cell acquisition using the information carried in the corresponding SSB and establish a communication link with a network entity.

The techniques for AI-based synchronization signal scanning and training thereof as described herein may provide various beneficial effects and/or advantages. The AI-based synchronization signal scanning described herein may reduce the error rate associated with detecting SSBs in a pre-scan, for example, with respect to a correlation-based energy scanning technique. For example, an ML model may be trained and/or configured to detect certain features, such as a shape (e.g., pattern) of an SSB to enable the improved accuracy of the SSB detection (e.g., reduce false alarms and/or miss detections). Such improved accuracy with respect to detecting an SSB may enable reduced latencies and/or power consumption for synchronization and cell acquisition. The AI-based synchronization signal scanning described herein may reduce the scan time with respect to a full frequency scan. Such a reduction in scan time may reduce the latencies and/or power consumption for synchronization and cell acquisition. The ML model training techniques described herein may enable an ML model that can adapt to various channel conditions and/or communication scenarios. For example, online training may enable the ML model to be trained under various channel conditions and/or communication scenarios. The ML model can be trained to detect shapes (e.g., patterns) of SSBs under various channel conditions and/or communication scenarios including, for example, line-of-sight conditions, non-line-of-sight conditions, various UE mobility states, various transmission ranges, various frequency bands, multi-path conditions, fading, scattering, interference, noise, etc. Thus, the ML model may be capable of detecting SSBs with improved accuracy, reduced latency, and/or reduced power consumption across various channel conditions and/or communication scenarios.

One technical problem with using an ML model trained and/or configured to detect certain features of an SSB may include that some SSB shapes or patterns may be harder to detect in noisy conditions. For example, an SSB shape or pattern may be similar to other types of communications that may occur. For example, a received waveform similar to an SSB may be falsely detected as an SSB, such as under noisy conditions.

Accordingly, certain aspects herein provide various SSB waveform shapes that may improve detectability by an ML model, thereby providing a technical benefit of improved SSB detection. For example, an SSB waveform shape may be configured to differ from other types of communications. In certain aspects, an SSB waveform shape may occupy one or more resources (e.g., time-frequency resources) and may not occupy one or more resources to form a pattern of occupied and unoccupied resources that differs from other types of communications. For example, the pattern may include blocks of occupied resources interspersed (e.g., interleaved) with blocks of unoccupied resources in a relatively unique pattern.

In certain aspects, a pattern includes a resource block (RB) that includes resource elements (REs) occupied by an SSB (e.g., occupied REs) and includes REs not occupied by an SSB (e.g., unoccupied REs). For example, occupied REs may be interleaved or interlaced with unoccupied REs. Such a pattern in an RB may differ from other communications that do not have occupied and unoccupied REs at a sub-RB granularity. Other example patterns for an SSB are further discussed herein that may provide a technical solution to the technical problem of detectability of features of an SSB.

### Introduction to Wireless Communications Networks

The techniques and methods described herein may be used for various wireless communications networks. While aspects may be described herein using terminology commonly associated with 3^{rd} Generation (3G), 4^{th} Generation (4G), 5^{th} Generation (5G), 6^{th} Generation (6G), and/or other generations of wireless technologies, aspects of the present disclosure may likewise be applicable to other communications systems and standards not explicitly mentioned herein.

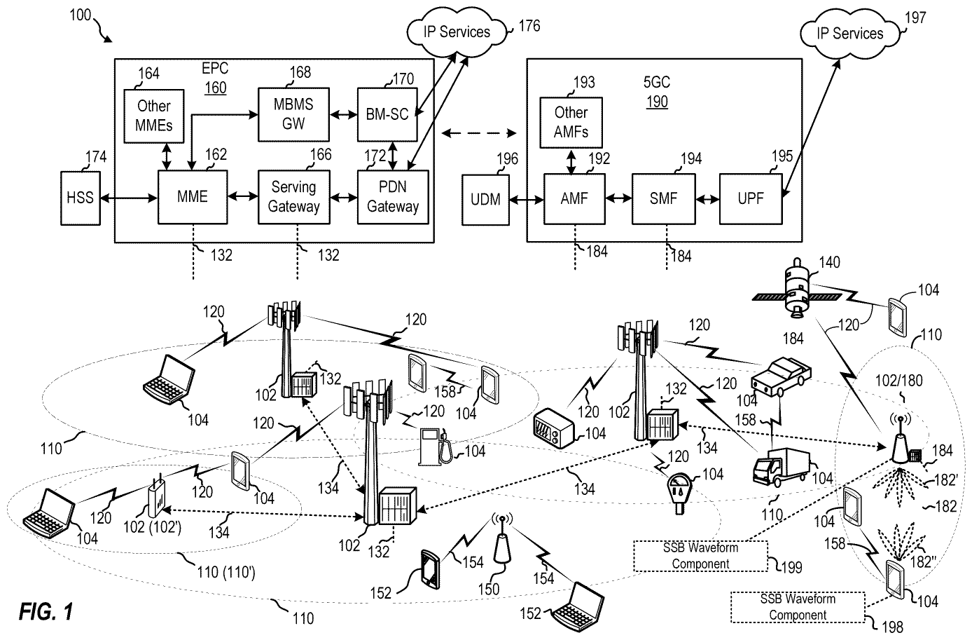

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a next generation NodeB (gNB) implemented at satellite 140 may implement higher-layer network functions. As another example, satellite 140 may be implemented according to a transparent architecture and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

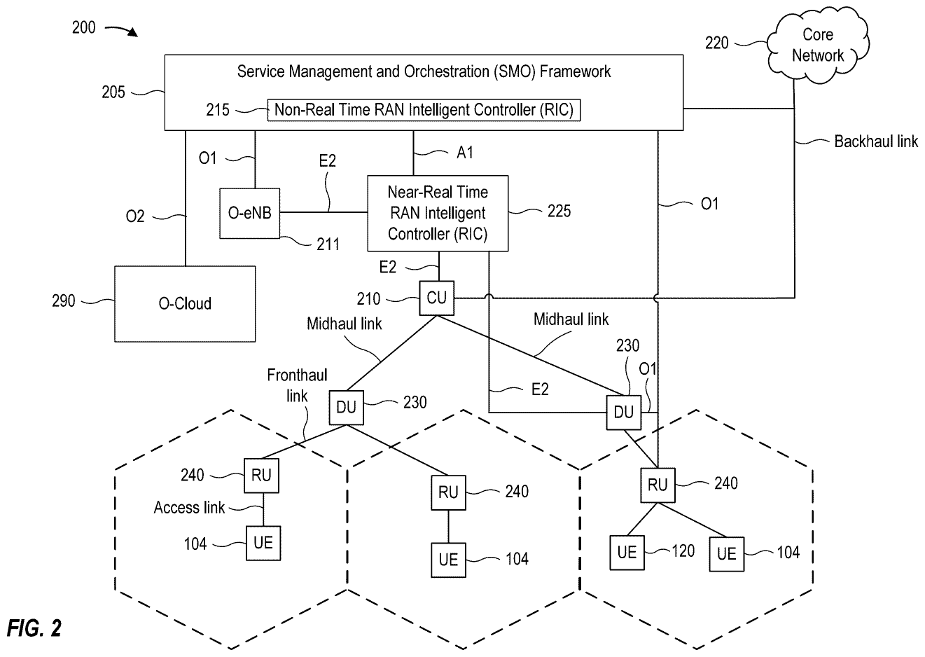

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., fifth generation (5G) New Radio (NR) or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHZ, 15 MHZ, 20 MHz, 100 MHz, 400 MHZ, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QOS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes an SSB waveform component 198, which may be used to detect SSBs based on features, such as shapes (e.g., patterns) of the SSBs as further described herein. Further, a BS 102 includes an SSB waveform component 199, which may be used to send SSBs with specific features, such as shapes (e.g., patterns) to enable an enhanced detectability of the SSBs at a UE 104 as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

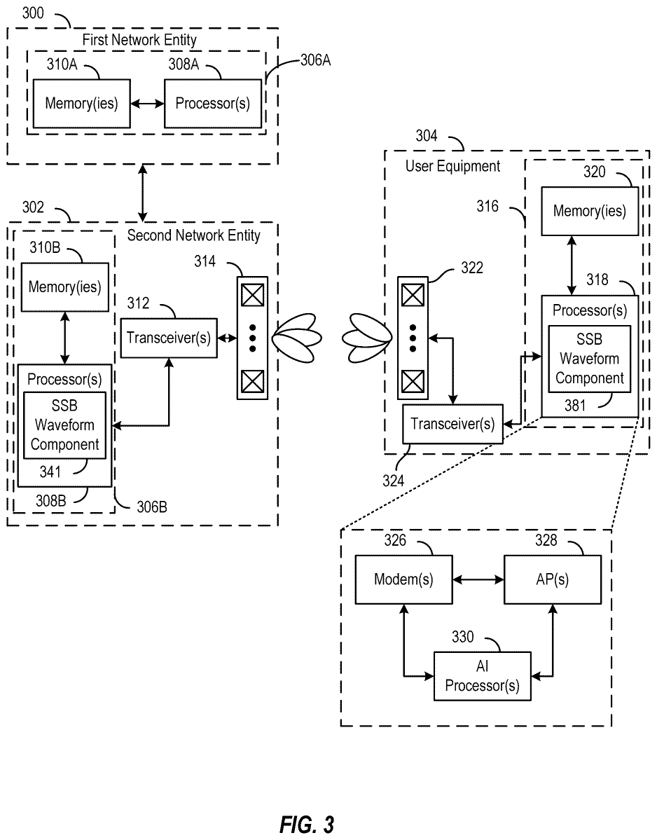

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306A” at first network entity 300 and “processing system 306B” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308A” and “processor(s) 308B”) and one or more memories 310 (illustrated as “memory (ies) 310A” and “memory (ies) 310B”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmit (TX) MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receive (RX) MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH) and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for single-carrier frequency division multiplexing (SC-FDM)), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306B such as a modem and/or an RX MIMO detector), and further processed by the processing system 306B (e.g., a modem and/or a receive processor) to obtain decoded data and control information sent by UE 304. The processing system 306B may provide the decoded data and the decoded control information (such as to a controller/processor of the processing system 306B, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308B includes an SSB waveform component 341, which may be representative of the SSB waveform component 199 of FIG. 1. Notably, while depicted as an aspect of processor(s) 308B, SSB waveform component 341 may be implemented additionally or alternatively in various other aspects of a network entity or a BS 102 in other implementations. Further, the processor(s) 318 includes an SSB waveform component 381, which may be representative of the SSB waveform component 198 of FIG. 1. Notably, while depicted as an aspect of the processor(s) 318, the SSB waveform component 381 may be implemented additionally or alternatively in various other aspects of a UE 104 in other implementations.

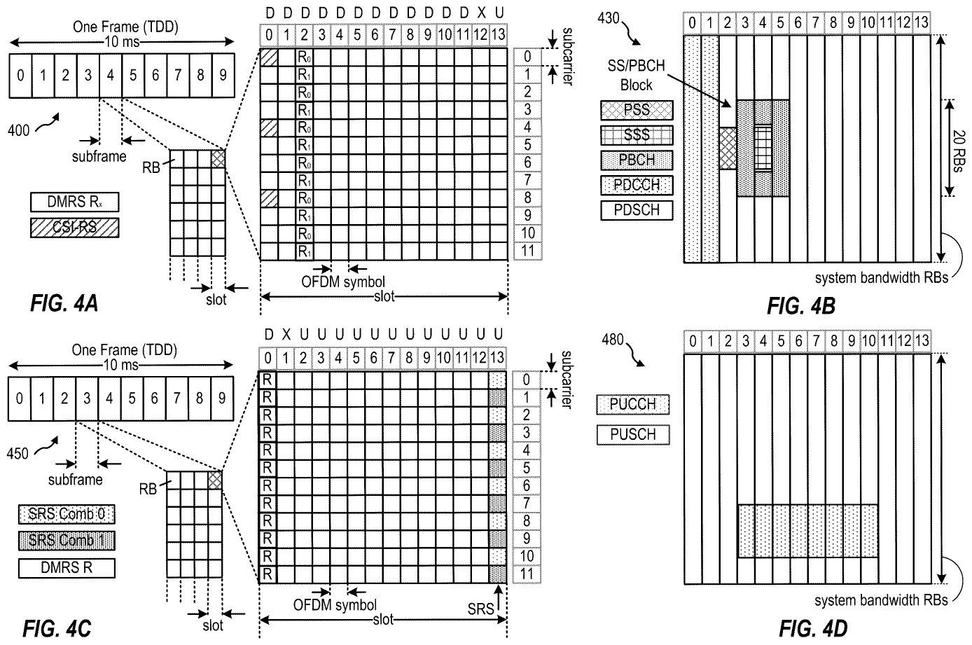

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (u) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 microseconds (μs).

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgement (ACK)/negative acknowledgement (NACK) feedback. The PUSCH carries data and may additionally be used to carry a buffer status report (BSR), a power headroom report (PHR), and/or UCI.

### Example Synchronization Signal Scanning

In certain wireless communications systems (e.g., 5G NR systems and/or future wireless communications systems), a UE may scan through frequencies for synchronization signals (e.g., an SSB) broadcasted by a network entity to establish a communication link with the network entity. In some cases, the UE may perform a full frequency scan (FFS) to search for the synchronization signals. As an example, devices enabled for worldwide deployment may perform scans over thousands of candidate frequencies to search for the synchronization signals. A synchronization raster may indicate the frequency positions of the synchronization signals that can be used by the UE for system acquisition when explicit signaling of the synchronization signals position is not present (for example, via system information). The frequency position of an SSB may be defined as SSREF with a corresponding global synchronization channel number (GSCN), which defines the center frequency of an SSB as further described herein. As an example synchronization raster, the parameters defining the SSREF and GSCN for certain frequency ranges are provided in Table 1 below.

TABLE 1
GSCN parameters for the global frequency raster

| Range of | SSB frequency | | Range of |
|---|---|---|---|
| frequencies (MHz) | position SS_{REF} | GSCN | GSCN |
| 0-3000 | N * 1200 kHz + | 3N + (M − | 2-7498 |
| | M * 50 kHz, | 3)/2 | |
| | N = 1:2499, M ∈ | | |
| | {1, 3, 5} | | |
| 3000-24250 | 3000 MHz + | 7499 + N | 7499-22255 |
| | N * 1.44 MHz, | | |
| | N = 0:14756 | | |
| 24250-100000 | 24250.8 MHz + | 22256 + N | 22256-26639 |
| | N * 17.28 MHz, | | |
| | N = 0:4383 | | |

To perform the FFS, the UE may assume the synchronization signals are transmitted with a particular periodicity (e.g., 20 ms) centered over certain GSCNs as provided by the synchronization raster. For example, the FFS may involve the UE monitoring for SSBs over the possible GSCNs sequentially as provided in Table 1. Such a scanning operation can take a relatively long time due to the large number of possible GSCNs (e.g., thousands of GSCNs) and the varying periodicities (e.g., ranging from 5 ms to 160 ms) that can be implemented for the SSB transmissions.

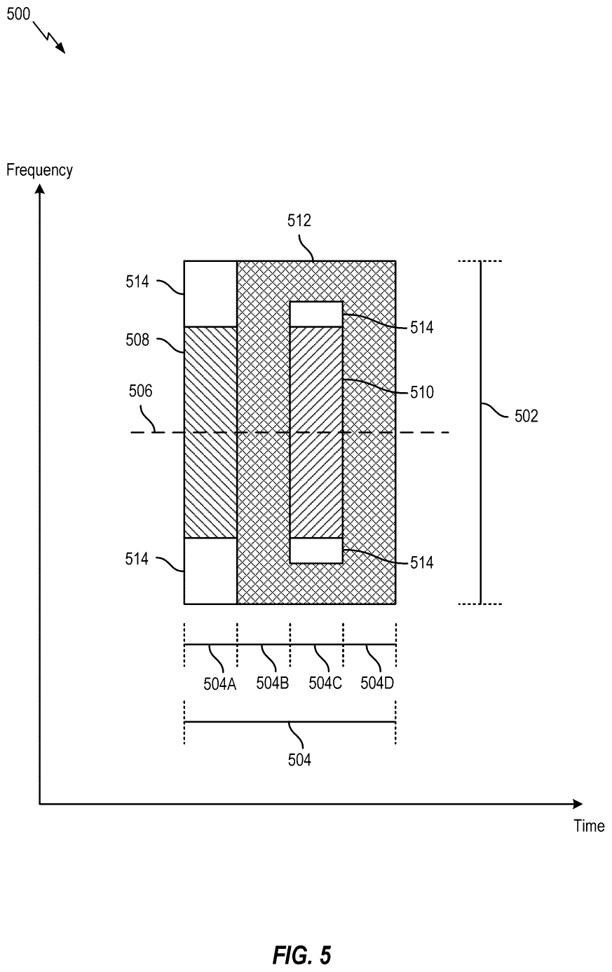

FIG. 5 illustrates an example SSB 500 in time and frequency domains. In this example, the SSB 500 occupies a frequency allocation 502 (e.g., 20 RBs in the frequency domain, such that the frequency allocation 502 includes 240 subcarriers and/or 240 REs in the frequency domain) and four symbols 504A-D (collectively symbols 504) in the time domain. In some aspects, the frequency allocation 502 and the four symbols 504A-D may form a plurality of RBs in the SSB 500. For example, an RE may include one subcarrier of the frequency allocation 502 with a duration of one of the symbols 504, and an RB may include a plurality of REs (e.g., 12 REs, such as 12 subcarriers in one of the symbols 504). The SSB 500 may have a center frequency 506 that corresponds to a GSCN and the SSREF according to a synchronization raster, such as the synchronization raster provided above in Table 1.

The SSB 500 may include a PSS 508, an SSS 510, and a PBCH 512. The PSS 508 occupies a first portion of the frequency allocation 502 (e.g., 127 subcarriers and/or 127 REs) in the first symbol 504A (e.g., symbol #n); the SSS 510 occupies the first portion of the frequency allocation 502 (e.g., 127 subcarriers and/or 127 REs) in the third symbol 504C (e.g., symbol #n+2); the PBCH 512 occupies the frequency allocation 502 in the second symbol 504B (e.g., symbol #n+1) and the fourth symbol 504D (e.g., symbol #n+3); and the PBCH 512 occupies a second portion of the frequency allocation 502 (e.g., 48 subcarriers and/or 48 REs) at the top and at the bottom of the SSB 500 in the third symbol 504C.

In some aspects, there may be empty time-frequency resources 514 arranged in the first symbol 504A and the third symbol 504C (e.g., for remaining subcarriers and/or REs in the frequency allocation 502 of the SSB 500 outside the PSS 508, the SSS 510, and the PBCH 512). For the empty time-frequency resources 514, the network entity (e.g., that is broadcasting the SSB 500) may perform a transmission with zero power or reduced power at the empty time-frequency resources 514, and/or the network entity refrains from transmitting data, signaling, and/or information in the empty time-frequency resources 514 (e.g., the empty time-frequency resources 514 may be referred to as “no transmission” regions in the SSB 500). In the example of the SSB 500, the empty time-frequency resources 514 may occupy a third portion of the frequency allocation 502 (e.g., 57 subcarriers and/or 57 REs) above the PSS 508 in the first symbol 504A and may occupy a fourth portion of the frequency allocation 502 (e.g., 56 subcarriers and/or 56 REs) below the PSS 508 in the first symbol 504A. The empty time-frequency resources 514 may also occupy a fifth portion of the frequency allocation 502 (e.g., nine subcarriers and/or nine REs) above the SSS 510 in the third symbol 504C and may occupy a sixth portion of the frequency allocation 502 (e.g., eight subcarriers and/or eight REs) below the SSS 510 in the third symbol 504C.

Note that the SSB 500 is merely an example structure for synchronization signaling, and other structures (e.g., different time and/or frequency domain arrangements for the PSS, SSS, and/or PBCH) may be used in addition to or instead of the structure depicted for the SSB 500. In some cases, synchronization signaling may be conveyed via a discovery reference signal having one or more synchronization signals, such as a PSS, a SSS, and/or a tertiary SS (TSS). In certain cases, some synchronization signaling may not have the PBCH.

A UE may use the PSS 508 and the SSS 510 for time and frequency synchronization for wireless communications with a network entity. As discussed herein, the PBCH 512 may carry certain system information (e.g., the MIB) that enables a UE to communicate with the network entity. In some aspects, the PBCH 512 may also include DMRS signaling. Note that, in some cases, the term “SSB” may refer to a SS/PBCH block.

In some aspects, the UE may scan and/or monitor for SSBs as part of a cell acquisition procedure to establish a connection with a network entity (e.g., that is broadcasting the SSBs) and/or a cell of the network entity. The cell acquisition procedure may involve coherent sequence correlation techniques, which may increase a latency for the UE to establish the connection with the network entity and/or cell. For example, the UE may expect to find SSBs at predefined GSCNs (e.g., prescribed frequency locations), where the UE may search each GSCN of the predefined GSCNs to detect a presence of SSBs. Subsequently, as part of the coherent sequence correlation techniques, SSB detection may be performed by the UE by correlating a received signal (e.g., from a detected SSB based on a GSCN) against known PSS and/or SSS sequences. Traditionally, these sequence correlation techniques may have a high complexity and/or result in high signal processing times, and as a result, latency may increase for UEs to establish the connection with the network entity and/or the cell for acquiring wireless communication services.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which includes data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

FIG. 6 illustrates an example AI architecture 600 that may be used for AI-enhanced wireless communications. As illustrated, the AI architecture 600 includes multiple logical entities, such as a model training host 602, a model inference host 604, data source(s) 606, and an agent 608. The AI architecture 600 may be used in any of various use cases for wireless communications, such as those listed above.

The model inference host 604, in the AI architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608.

The agent 608 may be an element or an entity of a wireless communication system including, for example, a radio access network (RAN), a wireless local area network, a device-to-device (D2D) communications system, etc. As an example, the agent 608 may be a user equipment (e.g., the UE 104 in FIG. 1), a base station (e.g., the BS 102 in FIG. 1) or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 608 may also depend on the type of tasks performed by the model inference host 604, the type of inference data 612 provided to model inference host 604, and/or the type of output 614 produced by model inference host 604.

For example, if output 614 from the model inference host 604 is associated with beam management, the agent 608 may be or include a UE, a DU, or an RU. As another example, if output 614 from model inference host 604 is associated with transmission and/or reception scheduling, the agent 608 may be a CU or a DU.

After the agent 608 receives output 614 from the model inference host 604, agent 608 may determine whether to act based on the output. For example, if agent 608 is a DU or an RU and the output from model inference host 604 is associated with beam management, the agent 608 may determine whether to change or modify a transmit and/or receive beam based on the output 614. If the agent 608 determines to act based on the output 614, agent 608 may indicate the action to at least one subject of the action 610. For example, if the agent 608 determines to change or modify a transmit and/or receive beam for a communication between the agent 608 and the subject of action 610 (e.g., a UE), the agent 608 may send a beam switching indication to the subject of action 610 (e.g., a UE). As another example, the agent 608 may be a UE, the output 614 from model inference host 604 may be one or more predicted channel characteristics for one or more beams. For example, the model inference host 604 may predict channel characteristics for a set of beams based on the measurements of another set of beams. Based on the predicted channel characteristics, the agent 608, such as the UE, may send, to the subject of action 610, such as a BS, a request to switch to a different beam for communications. In some cases, the agent 608 and the subject of action 610 are the same entity.

The data sources 606 may be configured for collecting data that is used as training data 616 for training an ML model, or as inference data 612 for feeding an ML model inference operation. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a beam configuration from agent 608, the subject of action 610 may provide performance feedback associated with the beam configuration to the data sources 606, where the performance feedback may be used by the model training host 602 for monitoring and/or evaluating the ML model performance, such as whether the output 614, provided to agent 608, is accurate. In some examples, if the output 614 provided to agent 608 is inaccurate (or the accuracy is below an accuracy threshold), the model training host 602 may determine to modify or retrain the ML model used by model inference host 604, such as via an ML model deployment/update.

In certain aspects, the model training host 602 may deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some other aspects, an ML model is deployed at or on a UE for SSB pre-scanning. More specifically, a model inference host, such as model inference host 604 in FIG. 6, may be deployed at or on the UE for indicating a probability of a GSCN being a center frequency of an SSB. Additionally or alternatively, the model inference host may be deployed at or on the UE for detecting an SSB based on specific feature(s), such as a shape of the SSB observed via one or more spectral energy images generated by the UE.

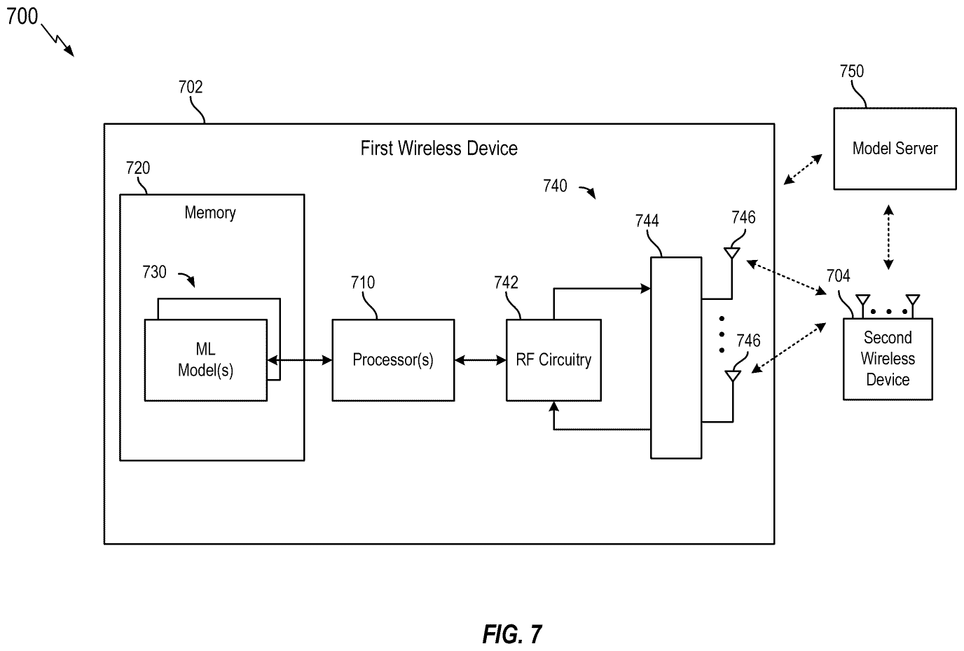

FIG. 7 illustrates an example AI architecture 700 of a first wireless device 702 that is in communication with a second wireless device 704. The first wireless device 702 may be an example of the UE 104 depicted and described with respect to FIG. 1 or the UE 304 depicted and described with respect to FIG. 3. Similarly, the second wireless device may be an example of the BS 102 depicted and described with respect to FIG. 1, the first network entity 300 or the second network entity 302 depicted and described with respect to FIG. 3, or a disaggregated base station depicted and described with respect to FIG. 2. Note that the AI architecture 700 of the first wireless device 702 may be applied to the second wireless device 704.

The first wireless device 702 may be, or may include, a chip, system on chip (SoC), system in package (SiP), chipset, package or device that includes one or more processors, processing blocks or processing elements (collectively “the processor 710”) and one or more memory blocks or elements (collectively “the memory 720”).

As an example, in a transmit mode, the processor 710 may transform information (e.g., packets or data blocks) into modulated symbols. As digital baseband signals (e.g., digital in-phase (I) and/or quadrature (Q) baseband signals representative of the respective symbols), the processor 710 may output the modulated symbols to a transceiver 740. The processor 710 may be coupled to the transceiver 740 for transmitting and/or receiving signals via one or more antennas 746. In this example, the transceiver 740 includes radio frequency (RF) circuitry 742, which may be coupled to the antennas 746 via an interface 744. As an example, the interface 744 may include a switch, a duplexer, a diplexer, a multiplexer, and/or the like. The RF circuitry 742 may convert the digital signals to analog baseband signals, for example, using a digital-to-analog converter. The RF circuitry 742 may include any of various circuitry, including, for example, baseband filter(s), mixer(s), frequency synthesizer(s), power amplifier(s), and/or low noise amplifier(s). In some cases, the RF circuitry 742 may upconvert the baseband signals to one or more carrier frequencies for transmission. The antennas 746 may emit RF signals, which may be received at the second wireless device 704.

In receive mode, RF signals received via the antenna 746 (e.g., from the second wireless device 704) may be amplified and converted to a baseband frequency (e.g., downconverted). The received baseband signals may be filtered and converted to digital I or Q signals for digital signal processing. The processor 710 may receive the digital I or Q signals and further process the digital signals, for example, demodulating the digital signals.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the 614 of FIG. 6) based on input data (e.g., the inference data 612 of FIG. 6), for example, as described herein with respect to the model inference host 604 of FIG. 6. The ML model 730 may be used to perform any of various AI-enhanced tasks, such as those listed above.

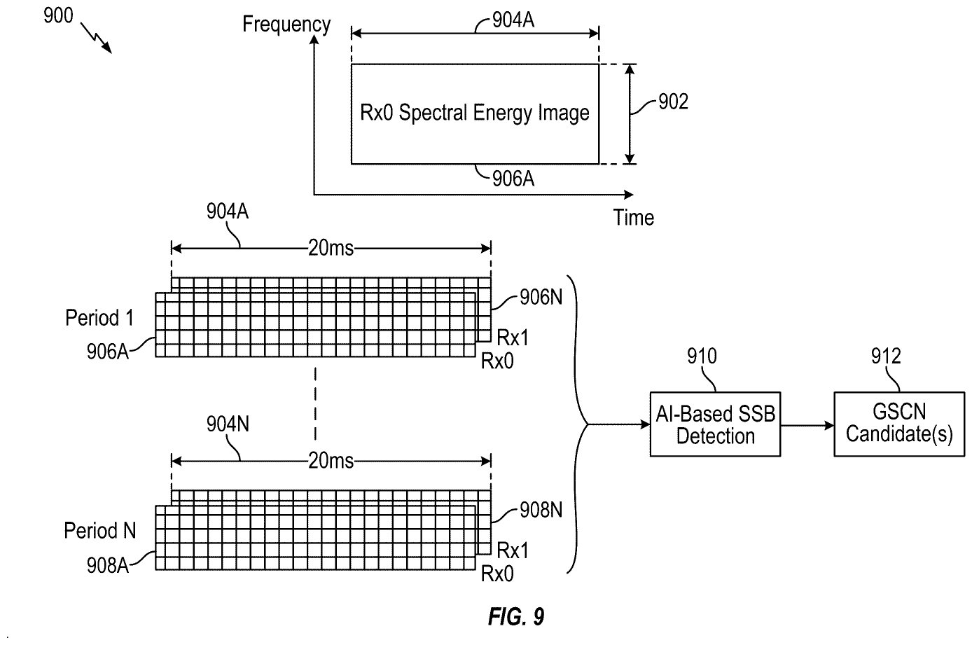

As further described herein with respect to FIGS. 9-12, the ML model 730 may obtain input comprising a spectral energy image. The ML model 730 may provide output indicating whether a GSCN corresponding to the center frequency of an SSB is detected in the spectral energy image. Note that other input data and/or output data may be used in addition to or instead of the examples described herein. For example, the ML model 730 may provide output indicating whether an SSB is detected based on specific feature(s), such as a shape of the SSB from the input of the spectral energy image.

In certain aspects, the model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 to collect and host training data, inference data, and/or performance feedback associated with an ML model 730. In certain aspects, the model server 750 may host various types and/or versions of the ML models 730 for the first wireless device 702 and/or the second wireless device 704 to download.

In some cases, the model server 750 may monitor and evaluate the performance of the ML model 730 to trigger one or more LCM tasks. For example, the model server 750 may determine whether to activate or deactivate the use of a particular ML model at the first wireless device 702 and/or the second wireless device 704, and the model server 750 may provide such an instruction to the respective first wireless device 702 and/or the second wireless device 704. In some cases, the model server 750 may determine whether to switch to a different ML model 730 being used at the first wireless device 702 and/or the second wireless device 704, and the model server 750 may provide such an instruction to the respective first wireless device 702 and/or the second wireless device 704. In yet further examples, the model server 750 may also act as a central server for decentralized machine learning tasks, such as federated learning.

### Example Artificial Intelligence Model

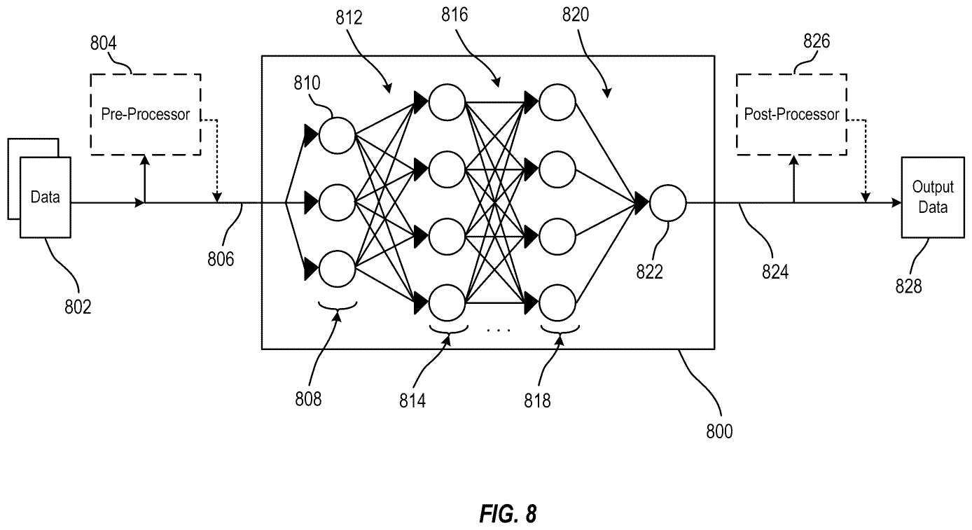

FIG. 8 is an illustrative block diagram of an example artificial neural network (ANN) 800.

ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., the inference data 612 in FIG. 6). Some non-exhaustive example activation functions include a linear function, binary step function, sigmoid, hyperbolic tangent (tanh), a rectified linear unit (ReLU) or variants thereof, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including written, visual, audio, environmental context, operational properties, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration. For example, in a feedforward ANN structure each artificial neuron 810 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 800 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 800 of FIG. 8.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more UEs, one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system or may be even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 800 of FIG. 8, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a UE or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Aspects Related to Artificial Intelligence-Based Synchronization Signal Scanning

Aspects of the present disclosure provide techniques for AI-based synchronization signal scanning as well as techniques for training the AI model(s) used for such scanning based on the SSB patterns configured for detection by the AI models.

FIG. 9 illustrates example operations 900 for performing an SSB pre-scan by a UE, such as the UE 104 of FIG. 1 or the UE 304 of FIG. 3. In this example, a UE may monitor a frequency bandwidth 902 over N number of time windows 904A-N (collectively the time windows 904) (e.g., Period 1 through Period N) via one or more antennas (e.g., antennas Rx0 and Rx1). The time windows 904 may be arranged consecutively in time to form a continuous monitoring time window.

In certain aspects, the UE may generate one or more spectral energy images for each of the time windows 904. As an example, the UE may obtain samples of a signal received via an antenna (Rx0) as monitored in the frequency bandwidth 902 over the first time window 904A. The UE may convert the samples into a first spectral energy image 906A, for example, as further described herein with respect to FIG. 10. A spectral energy image may be or include a time-frequency grid representing a spectral energy (e.g., a spectrogram or a matrix of values indicative of spectral energy over time) and/or an indication of the spectral energy over time. The frequency bandwidth 902 and the duration of the time window 904A may be selected to fit at least one SSB (e.g., the SSB 500 depicted and described with respect to FIG. 5) in the first spectral energy image 906A. In some cases, the UE may combine multiple spectral energy images 906A-N corresponding to the samples obtained via multiple antennas (e.g., antennas Rx0 and Rx1) in a given time window (e.g., the first time window 904A). The multiple antennas (e.g., antennas Rx0 and Rx1) may be arranged in different positions across the UE to enable spatial diversity for the pre-scanning. In some cases, the multiple antennas may be tuned to different frequency bands to enable frequency diversity for the pre-scanning, for example, as further described herein with respect to FIG. 10.

For the N-th time window 904N, the UE may generate one or more spectral energy images 908A-N corresponding to the samples obtained via the antenna(s) (e.g., antennas Rx0 and Rx1), for example, as described herein with respect to the first time window 904A. The UE may combine the spectral energy images generated across the time windows 904 into a multi-period spectral energy image. For example, the UE may perform non-coherent combining on the spectral energy images, which may improve the performance of the image compression techniques described herein (e.g., reduced latency, memory usage, etc.).

At 910, the UE may perform AI-based SSB detection on the combined spectral energy image, for example, as further described herein with respect to FIG. 10. The UE may predict SSB candidates using an AI model trained to detect one or more features of an SSB in the combined spectral energy image. That is, the UE may use the AI model to detect specific features of the SSB in the combined spectral energy image, such as a PSS, SSS, TSS, empty region(s) (e.g., no transmission region(s)), PBCH, etc. of the SSB. For example, the AI model may have a kernel tuned to an aspect ratio of an SSB in a time-frequency grid. In certain aspects, the kernel may have weights tuned to detect other suitable features of the SSB. Such an AI model may enable improved accuracy at detecting an SSB in a spectral energy image, and thus, the improved accuracy of the AI-based SSB detection can reduce the latency and/or power consumption of the SSB scanning. As an example, the UE may provide, to one or more AI models (e.g., the ML model(s) 730), input including the combined spectral energy image. The AI model(s) may output an indication of whether an SSB is detected in the combined spectral energy image. In certain aspects, the AI model(s) may output an indication of GSCN candidate(s) 912 that correspond to the center frequencies of SSB(s), for example, according to a synchronization raster as described herein with respect to FIG. 5. The UE may monitor for SSBs at the center frequencies corresponding to the GSCN candidate(s) 912, and the UE may perform cell acquisition via any detected SSB.

FIG. 10 illustrates example scanning operations 1000 for performing the SSB pre-scan as described herein with respect to FIG. 9. In this example, the UE obtains digital samples 1002 of a signal generated from monitoring a frequency bandwidth (e.g., the frequency bandwidth 902) via one or more antennas (e.g., antennas Rx0 and Rx1). The digital samples may be indicative of the RF energy in the frequency bandwidth as further described herein. As an example, the UE may monitor a frequency bandwidth using the transceiver 740 of FIG. 7. The UE may receive various radio waves in the frequency bandwidth, such as noise, interference, ambient radio waves, wireless communication signals, and/or pilot signals (e.g., the SSB 500). The UE may convert an analog signal generated using the RF circuitry 742 into a digital signal. In some cases, the UE may perform digital preprocessing operations on the digital signal (e.g., digital filtering and/or amplification) to generate the digital samples 1002.

At 1004, the UE may buffer the digital samples 1002, for example, by a downsampling ratio (e.g., 1/Nt, where Nt=8). The UE may downsample the digital samples 1002 by removing a portion of the samples per OFDM symbol, for example, binning an eighth of the samples corresponding to an OFDM symbol. At 1006, the UE may perform a fast Fourier transform (FFT) on the downsampled samples, for example, at a resolution of eight subcarrier spacings (SCSs). The FFT generates a frequency domain representation of the samples. In some cases, at 1008, the UE may perform droop compensation on the frequency domain representation of the samples, for example, to flatten the frequency response.

At 1010, the UE may determine spectral energy information per symbol, for example, using an absolute value function on the frequency domain representation of the samples. The UE may arrange the spectral energy information per symbol across a time sequence forming a spectral energy image 1050 (e.g., a spectrogram or a matrix of values indicative of spectral energy over time). The spectral energy image may be a representation of the spectral energy observed in a frequency bandwidth (e.g., the frequency bandwidth 902) over a time window (e.g., the time window 904A). In certain cases, the spectral energy image may be or include a matrix of spectral energy values arranged in a time-frequency grid. Note that the spectral energy image 1050 is depicted at a higher sampling resolution (time and frequency) than that is discussed above. In addition, the spectral energy image 1050 depicts an example of the spectral energy over time associated with an SSB (e.g., the SSB 500), and thus, an example SSB 1054 is depicted in the spectral energy image 1050. The UE may perform the operations at 1004 through 1010 for each of the digital samples 1002 obtained from all or some of the receive antennas (e.g., the antennas Rx0 and Rx1), which may enable frequency and/or spatial diversity for the SSB pre-scanning.

At 1012, the UE may combine the spectral energy images derived from the multiple receive antennas, for example, using an averaging function (or mean or median). For example, the UE may determine the average energy of each frequency-time position in the set of spectral energy images. For example, for each time-frequency position, the UE may select, in the spectral energy images, the energy values that correspond to a particular frequency and time (e.g., the first symbol in the time window at a frequency of 3 GHZ), and the UE may determine the average energy value for such energy values. Note that each frequency-time position in a spectral energy image may effectively be a pixel of the spectral energy image, and thus, the averaging function may be conceived as determining the average at each pixel across the set of spectral energy images. The combined spectral energy image formed at 1012 may be referred to as a multi-antenna spectral energy image.

At 1014, the UE may combine the multi-antenna spectral energy image of the current time window (e.g., the N-th time window 904N) with a spectral energy image 1052 generated for the previous time window (e.g., the time window occurring before the N-th time window 904N), which may be stored in and accessed via memory 1016 (e.g., the memory 720 in FIG. 7). For example, the UE may perform an averaging function (or mean or median) for each frequency-time position between the spectral energy images (1050 and 1052) of the current and previous time windows. If there is no previous spectral energy image, the UE may store the multi-antenna spectral energy image of the current time window in the memory 1016. In some cases, the spectral energy image 1052 may be a multi-period spectral energy image representative of the spectral energy across multiple time windows, for example, compressed into a duration of a single time window.

The UE may perform the operations at 1004 through 1014 for Nc number of time windows (e.g., the time windows 904). That is, the UE may combine the multi-antenna spectral energy images generated for Nc number of time windows into a multi-period spectral energy image as described above with respect to FIG. 9. At each iteration following the initial iteration, the UE may generate a multi-period spectral energy image representative of the combined spectral energy associated with the current spectral energy image 1050 and the previous spectral energy image 1052 and store the multi-period spectral energy image in the memory 1016 as discussed above with respect to 1014. As an example, the total number of time windows combined may be 12 for two receive antennas or six for four receive antennas, where each of the time windows has a duration of 20 ms. In some cases, a multi-period spectral energy image may be representative of the spectral energy over 120 ms to 240 ms compressed into a time window representative of 20 ms. Such spectral energy compression described above enables efficient processing of the SSB pre-scanning, for example, using AI-based processing as further described herein.

At any of the image combining operations described herein (e.g., at 1012 or 1014), the UE may perform non-coherent combining, which may disregard or not account for the phase associated with the images being combined. Such non-coherent combining may allow the UE to perform the image combining with improved performance, for example, reduced processing latency, reduced processing usage, reduced memory usage, etc.

At 1018, the UE may demultiplex (e.g., crop) the multi-period spectral energy image into sub-images, where each sub-image may span a portion of the bandwidth and/or time window of the source image. As an example, due to multi-antenna monitoring that supports frequency diversity (e.g., monitoring a system bandwidth), the multi-period spectral image may have spectral energy information that spans a bandwidth, such as one or more frequency ranges (e.g., the range of GSCNs including 2-7498). The demultiplexing may segment the multi-period spectral energy image into sub-images, where each sub-image represents a sub-bandwidth (e.g., 80-100 MHz) of the source image. In some cases, the demultiplexing may segment the multi-period spectral energy image into sub-images, where each sub-image represents a portion of the time window, e.g., 1 slot, of the source image. The time-frequency dimensions of a sub-image may be selected to fit at least one SSB, such as the example SSB 1054 as illustrated in the spectral energy image 1050. In certain aspects, the frequency bandwidth of a sub-image may include multiple GSCNs. In certain cases, the sub-images may overlap with each other in time and/or frequency dimension(s). In some cases, the sub-images may not overlap with each other in time and/or frequency dimension(s).

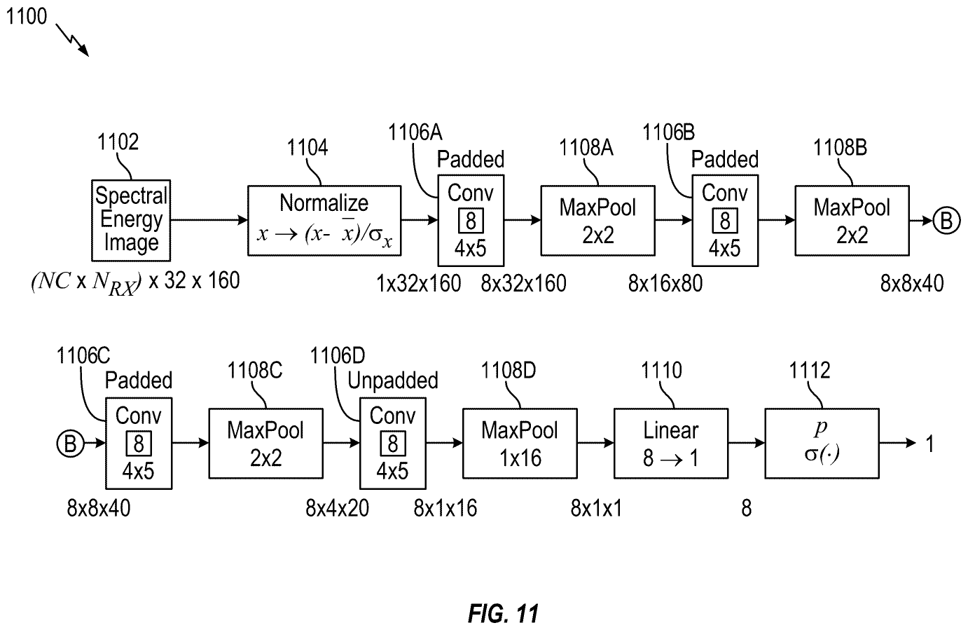

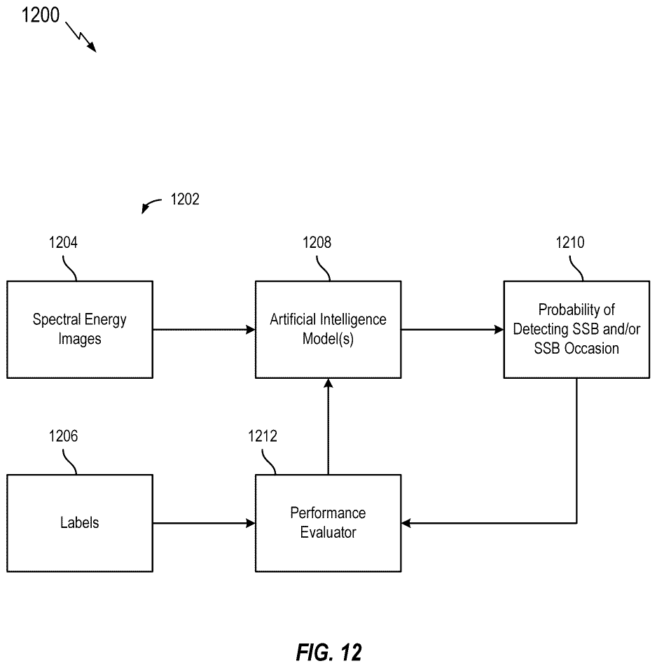

As a representative example of SSB detection for a spectral energy image, at 1020, the UE may normalize the spectral energy image obtained from the demultiplexing at 1018. For example, the spectral energy image may be normalized based on the mean and the standard deviation of the spectral energy image, for example, as further described herein with respect to FIG. 11. At 1022, the UE may provide the normalized spectral energy image to an AI model 1022 (e.g., the ML model(s) 730) trained to detect an SSB (e.g., the SSB 500 and/or the example SSB 1054) and/or an SSB occasion as further described herein with respect to FIGS. 11 and 12. In certain aspects, the AI model 1022 may be trained to detect one or more features of an SSB, such as the aspect ratio of the SSB in a time-frequency grid and/or a shape of the SSB (e.g., based on areas of empty time-frequency resources around a PSS and/or an SSS as depicted and described with respect to FIG. 5). For example, the AI model 1022 may have a kernel tuned to the aspect ratio of the SSB. Such training and/or configuration of the AI model 1022 may enable improved accuracy at detecting an SSB in a spectral energy image (e.g., based on a shape of the SSB in the spectral energy image), and thus, reduce the latency and/or power consumption of the SSB scanning. In certain aspects, the AI model 1022 may be or include a convolutional neural network (CNN). As a more specific example, the AI model 1022 may be or include a two-dimensional (2D) CNN. The UE may obtain output from the AI model 1022, where the output may include a probability of detecting an SSB at a particular GSCN and the corresponding SSB occasion (e.g., symbol location). At 1024, the UE may evaluate the output of the AI model 1022 based on one or more thresholds 1026. For example, the UE may determine that a GSCN candidate corresponding to an SSB is detected in the spectral energy image if the probability is greater than or equal to the threshold(s) 1026 (e.g., ≥50%, 75%, or 95%).

The UE may repeat the operations at 1020 through 1024 for all or some of the spectral energy images obtained from the demultiplexing at 1018. For example, the UE may process the spectral energy images for all the slots within the 20 ms time window and GSCNs in the bandwidth of the multi-period spectral energy image. In certain aspects, the UE may perform the operations at 1020 through 1024 for multiple spectral energy images via parallel processing to efficiently pre-scan a bandwidth for SSBs. The UE may concurrently process the multiple spectral energy images through the AI model 1022. Through the AI-based pre-scanning, the UE may obtain GSCN candidates 1028 that correspond to the center frequencies of SSBs and/or the SSB occasion in which the SSBs may be received. Additionally or alternatively, through the AI-based pre-scanning and/or processing the multiple spectral energy images through the AI model 1022, the UE may detect an SSB based on specific feature(s), such as a shape of the SSB.

### Example Convolutional Neural Network for SSB Detection

FIG. 11 illustrates an example CNN 1100 that is trained to detect an SSB and/or an SSB occasion thereof. The CNN 1100 may be an example of the AI model 1022 as described with respect to FIG. 10 and/or an example of the ANN 800 as described with respect to FIG. 8. The CNN 1100 may include a feedforward neural network and/or a recurrent neural network. The CNN 1100 may receive input 1102, which may include a spectral energy image as described with respect to FIGS. 9 and 10. In some cases, the CNN 1100 may include a pre-processor 1104, for example, as described herein with respect to FIG. 8. In this example, the pre-processor 1104 may normalize the input 1102 (x) according to Equation (1) as follows:

$${x}_{norm} = \frac{( x - \overline{x} )}{{σ}_{x}} \qquad ( 1 )$$

where x̅ is the mean of the input 1102, and σₓ is the standard deviation of the input 1102. Note that the pre-processor 1104 may perform the normalization at 1020 of FIG. 10. Thus, in some cases, the normalization may be integrated with the AI model.

The CNN 1100 may process the spectral energy image of the input 1102 through a pipeline of layers. The CNN 1100 may include a plurality of convolutional layers 1106A-D, a set of pooling layers 1108A-D, and a fully connected layer 1110. As shown, at least one pooling layer is arranged between two of the convolutional layers. The first convolutional layer 1106A may receive input from the pre-processor 1104 and provide output to the first pooling layer 1108A. The first pooling layer 1108A processes the output of the first convolutional layer 1106A and provides output to the second convolutional layer 1106B. The second convolutional layer 1106B processes the output of the first pooling layer 1108A and provides output to the second pooling layer 1108B, and so on for the subsequent convolutional layers and pooling layers arranged in the CNN 1100.

The first convolutional layer 1106A may include one or more filters, for example, one to eight filters. Each of the filters may output a feature map associated with the input. As an example, eight filters output eight feature maps for the spectral energy image. In certain aspects, each of the filters (or some of the filters) may be configured or trained to detect a specific feature of the SSB, for example, via specific weights or coefficients of the respective filter. A feature of the SSB (for which a filter is configured and/or trained to detect) may include, for example, the PSS, SSS, TSS, empty region(s) (e.g., the empty time-frequency resources 514 depicted and described with respect to FIG. 5), PBCH, time-frequency arrangements/dimensions thereof, a sequence signature of any SS, etc. The time-frequency arrangement(s) and/or dimension(s) may refer to the arrangement and/or dimensions of the PSS, SSS, TSS, and/or PBCH in an SSB or any other suitable synchronization signal specification, for example, as described herein with respect to FIG. 5.

In certain aspects, each of the filters (or some of the filters) may have a kernel size that is tuned to the aspect ratio of an SSB in the time-frequency domains. The kernel may have dimensions that match (or correspond to) the time-frequency dimensions of an SSB in the spectral energy image of the input 1102. The aspects ratio of the kernel (e.g., size or dimension) may match the aspect ratio of an SSB in the spectral energy image. For example, the kernel may be sized to effectively form a bounding box around an SSB in the spectral energy image of the input 1102. As an example, the kernel size may be four by five (e.g., 4×5). Note that the kernel size may depend on the time-frequency resolution of the spectral energy image of the input 1102.

In certain aspects, the first convolutional layer 1106A may apply padding (e.g., same padding) for the filters to enable the output to have the same dimensions as the input. The first convolutional layer 1106A may apply an activation layer (e.g., an activation function) to prepare the output for the next convolutional layer. The activation layer may be or include a ReLU function, for example.

A first pooling layer 1108A may perform a pooling operation (e.g., maximum pooling) on the input data received from the first convolutional layer 1106A. The first pooling layer 1108A may downsample the input data received from the first convolutional layer 1106A. In certain aspects, the first pooling layer 1108A may be or include a maximum pooling layer. As an example, the first pooling layer 1108A may have a size of two by two. Note that the first pooling layer 1108A may perform other types of pooling in addition to or instead of maximum pooling, such as average pooling, median pooling, etc.

In certain aspects, the first convolutional layer 1106A may be an example of the second convolutional layer 1106B, the third convolutional layer 1106C, and the fourth convolutional layer 1106D. In some cases, the second convolutional layer 1106B and third convolutional layer 1106C may have the same convolutional filtering architecture as the first convolutional layer 1106A. For example, each of the second convolutional layer 1106B and third convolutional layer 1106C may have a plurality of filters (e.g., eight filters) with a kernel size that is tuned to the aspect ratio of the SSB and applies padding. In some cases, the fourth convolutional layer 1106D may be unpadded to reduce the dimensions of the feature map extracted from the input.

In certain aspects, the first pooling layer 1108A may be an example of the second pooling layer 1108B, the third pooling layer 1108C, and the fourth pooling layer 1108D. In some cases, the second pooling layer 1108B and the third pooling layer 1108C may have the same architecture as the first pooling layer 1108A. For example, each of the second pooling layer 1108B and the third pooling layer 1108C may perform maximum pooling having a size of two by two. In certain cases, the fourth pooling layer 1108D may have a size (e.g., one by sixteen) to downsample the input obtained from the fourth convolutional layer 1106D into an array (e.g., eight by one) of features.

The fully connected layer 1110 may apply weights to the features extracted through the previous layers to transform the features into an output 1112 associated with SSB detection. For example, the output 1112 may include a probability of an SSB being detected in the spectral energy image of the input 1102, the corresponding center frequency GSCN for the SSB (e.g., a GSCN candidate), and/or the corresponding candidate SSB occasion(s). In certain aspects, the fully connected layer 1110 may use a sigmoid activation function. The SSB occasion may indicate when the predicted SSB is expected to occur in time. As an example, the SSB occasion may be indicated in terms of a symbol index in a slot and/or a half frame.

### Aspects of Training a Machine Learning Model for SSB Detection

FIG. 12 illustrates example operations 1200 for training an AI model to detect an SSB. The operations 1200 may be performed by a model training host (e.g., the model training host 602 of FIG. 6). In some cases, the model training host may be or include a UE (e.g., the UE 104) and/or a network entity (e.g., the BS 102). In certain aspects, the model training host may be or include a base station (e.g., the BS 102), a disaggregated entity thereof (e.g., CU 210, DU 230, and/or RU 240), a network entity of a core network (e.g., the 5GC 190), and/or a network entity of a cloud-based RAN (e.g., Near-RT RICs 225, the Non-RT RICs 215, and/or the SMO Framework 205 of FIG. 2).

The model training host obtains training data 1202 including training input data 1204 and corresponding labels 1206 for the training input data 1204. The training input data 1204 may include spectral energy images, for example, as described herein with respect to FIG. 10. The spectral energy images may be simulated (e.g., computer generated) and/or harvested from SSB scanning. In certain aspects, the spectral energy images may include a distribution of spectral energy images having an SSB or not having an SSB. In some cases, the spectral energy images may include partial SSBs where a portion of the SSB is outside the spectral energy image.

In certain aspects, the spectral energy images may include spectral energy images obtained from SSB scanning in various channel conditions. For example, the spectral energy images may include spectral energy information measured at various frequency ranges (e.g., FR1 and FR2), signal qualities (e.g., low to high signal-to-noise ratios (SNRs)), signal strengths (e.g., low to high reference signal received powers (RSRPs)), signal propagation effects (e.g., scattering, fading, Doppler effects, etc.), UE mobility states (e.g., low, medium, and high mobility), interference levels, noise levels, transmission ranges (e.g., proximity to a cell), line of sight conditions, non-line of sight conditions, etc. An AI model may be trained to detect an SSB in a wide range of channel conditions (e.g., FR1 and FR2) and/or in specific channel conditions (e.g., FR2).

Each of the labels 1206 may be associated with at least one of the spectral energy images. As an example, each of the labels 1206 may include an indication of whether any SSB is in the respective spectral energy image. In some cases, for the labels that indicate an SSB is in the respective spectral energy image, the label may include an indication of a corresponding SSB occasion (e.g., a time interval in which the SSB occurs).

The model training host provides the training input data 1204 to an AI model 1208. In certain aspects, the AI model 1208 may include the CNN 1100 of FIG. 11, and the AI model 1208 may be an example of the AI model(s) described herein with respect to FIGS. 6-10. The AI model 1208 provides an output 1210, which may include the SSB detection information as described herein with respect to FIGS. 9-11.

The model training host provides the output 1210 of the AI model 1208 to a performance evaluator 1212 that evaluates the quality and/or accuracy of the output 1210. The performance evaluator 1212 may determine whether the output 1210 matches the corresponding label of the training input data 1204. For example, the performance evaluator 1212 may determine whether the prediction that an SSB is detected in a spectral energy image is correct based on the label associated with the spectral energy image. The performance evaluator 1212 may adjust the AI model 1208 (e.g., any of the weights in a convolutional layer) to reduce a loss associated with the AI model 1208. The model training host may continue to provide the training input data 1204 to the AI model 1208 and adjust the AI model 1208 until the loss of the AI model 1208 satisfies a threshold and/or reaches a minimum loss. In certain aspects, the loss may include a sum of squared of errors (SSE) loss, an intersection of union (IoU) loss, a cross-entropy loss, or a combination thereof.

In certain aspects, the model training host may train multiple AI models. The AI models may be trained with different performance characteristics and/or for different channel conditions. For example, the AI models may be trained to detect an SSB with different levels of accuracy (e.g., accuracies of 70%, 80%, or 99%), different latencies (e.g., the processing time to predict the SSB), and/or different throughputs (e.g., the capacity to predict SSBs from one or more spectral energy images). In some cases, the AI models may be trained to detect an SSB in different channel conditions as described above. Thus, the UE may select the AI model that is capable of detecting an SSB in accordance with certain specification(s) and/or conditions, such as the current channel conditions, a specific level of power consumption, a specific latency, and/or a specific accuracy. In certain aspects, such AI models may enable the UE to perform SSB scanning with improved accuracy of detecting GSCN candidates, and thus, the improved accuracy of detecting GSCN candidates can enable reduced cell acquisition times and/or reduced power consumption.

FIG. 13 illustrates an example 1300 of scan times over signal qualities for an AI-based SSB scanning technique (e.g., the scanning operations 1000 of FIG. 10) and an FFS technique. As shown, a first set of scan times 1302 is associated with an AI-based SSB scanning technique, and a second set of scan times 1304 is associated with an FFS technique. The AI-based SSB scanning technique provides shorter SSB scan times compared to the FFS technique over a range of signal qualities. In some cases, the AI-based SSB scanning technique can reduce the scanning time by a reduction 1306 of more than 60%. Moreover, the AI-based SSB scanning technique provides improved accuracy with respect to detecting an SSB in a frequency bandwidth using a spectral energy correlation technique. The improved accuracy may be attributable to an AI model (e.g., a CNN) configured to detect and extract various features of an SSB and/or robust AI model training, for example, as described herein with respect to FIG. 12. Thus, the AI-based SSB scanning technique described herein may enable reduced latencies and/or power consumption for synchronization and cell acquisition.

While the examples depicted in FIGS. 9-13 are described herein with respect to detecting an SSB via an AI model to facilitate understanding, aspects of the present disclosure may also be applied to other synchronization signaling schemes, such as a discovery reference signal (DRS) having one or more synchronization signals, and in some cases, not having a PBCH.

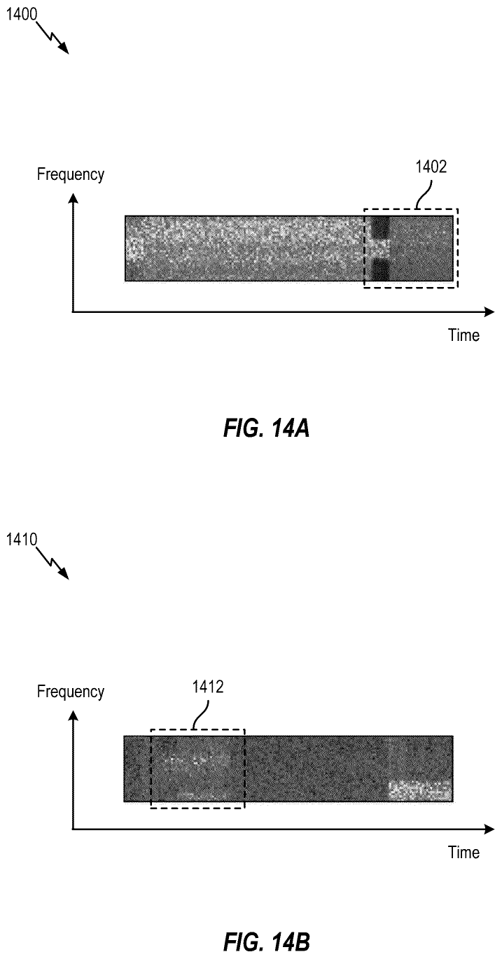

FIGS. 14A and 14B depict example spectral energy images for detecting an SSB. For example, FIG. 14A depicts a first spectral energy image 1400, and FIG. 14B depicts a second spectral energy image 1410. In some aspects, the first spectral energy image 1400 and the second spectral energy image 1410 may represent example spectral energy images generated by a UE as described with respect to FIGS. 9-12, where the UE uses the spectral energy images to attempt to detect an SSB using AI (e.g., ML) techniques.

For example, based on the techniques described with respect to FIGS. 6-13, the UE may employ non-coherent ML-based detection algorithms (an example of AI-based SSB scanning techniques) to detect an SSB (e.g., for cell acquisition). In some aspects, this non-coherent, energy-based technique can be used to detect an SSB by using specific features, such as the specific shape with which the SSB appears in a spectral energy image (e.g., an image corresponding to a 2D time-frequency energy spectrum). In the example of the SSB 500 depicted and described with respect to FIG. 5, an SSB may include a shape with regions of empty time-frequency resources (e.g., no transmission regions) around a PSS and an SSS. By treating a 2D energy spectrum as an image (e.g., with the spectral energy image(s)), ML-based techniques can be used effectively to detect SSB(s) based on the shape of the SSB(s) and/or detecting GSCN candidates as described with respect to FIGS. 6-13. In some aspects, these non-coherent, ML-based detection algorithms may accelerate cell acquisition procedure and consume lower power compared to coherent, non-ML algorithms (e.g., the coherent sequence correlation techniques described previously with respect to FIG. 5). For example, a complexity for the ML-based techniques may be lower than the non-ML-based techniques, which may allow for signal processing parallelization to speed up cell acquisition and to lower power consumption.

However, in some cases, the shape of the SSB (e.g., the shape of the SSB 500 depicted and described with respect to FIG. 5 and/or the example SSB 1054 depicted and described with respect to FIG. 10) may cause issues for the ML-based techniques that enable the UE to detect the SSB in a spectral energy image. For example, as depicted in the example of FIG. 14A, the first spectral energy image 1400 may include a shape 1402 that is generated by other types of wireless communications signaling than an SSB, such as a downlink control channel (e.g., a PDCCH) and a downlink shared channel (e.g., a PDSCH), where the shape 1402 is similar to the shape of the SSB. As such, the UE may experience a false alarm by detecting the shape 1402 (e.g., via the described ML-based techniques) when the signaling that generates the shape 1402 is not an SSB, which may increase latency for cell acquisition. Additionally or alternatively, in the example of FIG. 14B, the second spectral energy image 1410 may include a region 1412 that includes the shape of the SSB, but the UE may experience a miss detection of the shape of the SSB in the region 1412 (e.g., via the described ML-based techniques) because the shape of the SSB may not be discernible from noise in the second spectral energy image 1410.

### Example SSB Waveforms

As described herein, one or more SSB waveform designs (e.g., patterns) are provided for enhanced shape-based detection of SSBs at a UE, such as by an ML model configured to detect SSBs as described with respect to FIGS. 6-13. For example, the different SSB waveform designs (e.g., patterns) provided herein may include more pronounced and peculiar shapes of SSBs to aid the shape-based detection. In certain aspects, the different SSB waveform designs (e.g., patterns) provided herein may lower the number of false alarms (e.g., as depicted and described with respect to FIG. 14A) and/or miss detections (e.g., as depicted and described with respect to FIG. 14B) from shape-based detections of SSBs, while remaining backward compatible with correlation-based algorithms (e.g., coherent sequence correlation techniques).

FIGS. 15-18 include respective example SSB waveform designs (e.g., patterns) for the shape-based detection of SSBs described herein. Generally, the example SSB waveform designs (e.g., patterns) depicted and described with respect to FIGS. 15-18 may include varying the shape of an SSB (e.g., with respect to the shape of the SSB 500 depicted and described with respect to FIG. 5). For example, the example SSB waveform designs (e.g., patterns) depicted and described with respect to FIGS. 15-18 may include increased regions of empty time-frequency resources (e.g., increased no transmission regions) compared to the SSB 500 depicted and described with respect to FIG. 5. Additionally or alternatively, the example SSB waveform designs (e.g., patterns) depicted and described with respect to FIGS. 15-18 may distribute the regions of empty time-frequency resources over the four symbols of the SSB to create peculiar pattern(s). For example, the SSB may include a first set of resources that carry the PSS, SSS, PBCH, etc. (e.g., the SSB occupies the first set of resources) and a second set of resources that include the empty time-frequency resources (e.g., the SSB does not occupy the second set of resources), where the first set of resources and the second set of resources form the peculiar pattern(s). In some aspects, the peculiar pattern(s) may not be able to be generated by other types of wireless communications signals, such that the peculiar pattern(s) may enable enhanced detectability by an ML model configured to detect the SSBs (e.g., as described with respect to FIGS. 6-13).

In some aspects, the peculiar pattern(s) between the first set of resources (e.g., transmission REs and/or occupied REs) and the second set of resources (e.g., no transmission REs and/or unoccupied REs) may be used to encode information, such as identifiers (IDs) of a PSS and/or an SSS of the SSB and/or may be used to encode a MIB carried by a PBCH of the SSB, such as similar to a quick-response (QR) code. Additionally or alternatively, a transmission power of the first set of resources (e.g., carrying the PSS, SSS, and/or PBCH of the SSB) may be varied across the symbols of the SSB, such that a brightness pattern of the SSB in a corresponding spectral energy image (e.g., 2D energy spectrum) may be peculiar to enable the enhanced detectability of SSBs by the ML model described herein. That is, by varying the transmission power across the symbols of the SSB, a brightness of the first set of resources of the SSB may vary across resources in the corresponding spectral energy image to increase the peculiarity of the SSB and enhance the detectability of the SSB by the ML model. In certain aspects, power used for communication of the PSS, SSS, and/or PBCH may differ, such as between one another, to vary the brightness.

FIG. 15 illustrates an example SSB 1500 in time and frequency domains. In some examples, the SSB 1500 may implement aspects of or may be implemented by aspects of FIGS. 1-14B. For example, a network entity may broadcast the SSB 1500, and a UE may scan for and obtain the SSB 1500 to acquire synchronization information and/or other information to establish a communication link with the network entity as depicted and described with respect to FIG. 5. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3.

In some aspects, the SSB 1500 may include similar aspects as the SSB 500 depicted and described with respect to FIG. 5, but the SSB 1500 may represent a different shape (e.g., pattern of resources) than the SSB 500. For example, the SSB 1500 occupies a frequency allocation 1502 (e.g., 24 RBs in the frequency domain, such that the frequency allocation 1502 includes 288 subcarriers and/or 288 REs) and four symbols 1504A-D (collectively symbols 1504) in the time domain. The SSB 1500 may have a center frequency 1506 that corresponds to a GSCN and the SSREF according to a synchronization raster (e.g., the synchronization raster provided above in Table 1). The SSB 1500 may include a PSS 1508, an SSS 1510, a PBCH 1512, and empty time-frequency resources 1514.

In the example of the SSB 1500, the PSS 1508 may occupy a first portion of the frequency allocation 1502 (e.g., 127 subcarriers and/or 127 REs) in the first symbol 1504A (e.g., symbol #n); the SSS 510 may occupy the first portion of the frequency allocation 1502 (e.g., 127 subcarriers and/or 127 REs) in the third symbol 1504C (e.g., symbol #n+2); and the PBCH 1512 may occupy the frequency allocation 1502 in the second symbol 1504B (e.g., symbol #n+1) and the fourth symbol 1504D (e.g., symbol #n+3). Additionally, there may be the empty time-frequency resources 1514 arranged in the first symbol 1504A and the third symbol 1504C (e.g., for remaining subcarriers and/or REs in the frequency allocation 1502 outside the PSS 1508 and the SSS 1510). In the example of the SSB 1500, the empty time-frequency resources 1514 may occupy a second portion of the frequency allocation 1502 (e.g., 81 subcarriers and/or 81 REs) above the PSS 1508 in the first symbol 1504A and above the SSS 1510 in the third symbol 1504C. The empty time-frequency resources 1514 may also occupy a third portion of the frequency allocation 1502 (e.g., 80 subcarriers and/or 80 REs) below the PSS 1508 in the first symbol 1504A and below the SSS 1510 in the third symbol 1504C.

In some aspects, a pattern for the SSB 1500 (e.g., a shape of the SSB 1500) may be formed between a first set of resources (e.g., for the PSS 1508, the SSS 1510, and the PBCH 1512) and a second set of resources (e.g., for the empty time-frequency resources 1514), where the pattern for the SSB 1500 is different than a pattern of the SSB 500 (e.g., a shape of the SSB 500) depicted and described with respect to FIG. 5. For example, the PBCH 1512 may not be transmitted in the third symbol 1504C in the example of the SSB 1500, while the PBCH 512 is transmitted in one or more portions of the third symbol 504C in the example of the SSB 500. Additionally, the portions of the SSB 1500 occupied by the empty time-frequency resources 1514 may be larger than the portions of the SSB 500 occupied by the empty time-frequency resources 514. For example, the second portion and the third portion of the frequency allocation 1502 that are occupied by the empty time-frequency resources 1514 for the SSB 1500 may be larger than the corresponding portions of the frequency allocation 502 that are occupied by the empty time-frequency resources 514 for the SSB 500. In particular, the third symbol 1504C may include larger portions occupied by the empty time-frequency resources 1514 compared to the portions occupied by the empty time-frequency resources 514 in the third symbol 504C.

Accordingly, these differences in the pattern for the SSB 1500 compared to the pattern of the SSB 500 (e.g., no PBCH 1512 in the third symbol 1504C, the larger portions occupied by the empty time-frequency resources 1514, etc.) may enable the UE to detect the SSB 1500 more successfully and/or reliably via an AI model (e.g., ML model) described herein compared to the pattern of the SSB 500. For example, the pattern for the SSB 1500 may not be formed by other types of signaling, such that the AI model is able to more successfully and/or reliably detect the SSB 1500 in spectral energy images based on detecting the pattern for the SSB 1500 compared to potentially falsely detecting the pattern for the SSB 500.

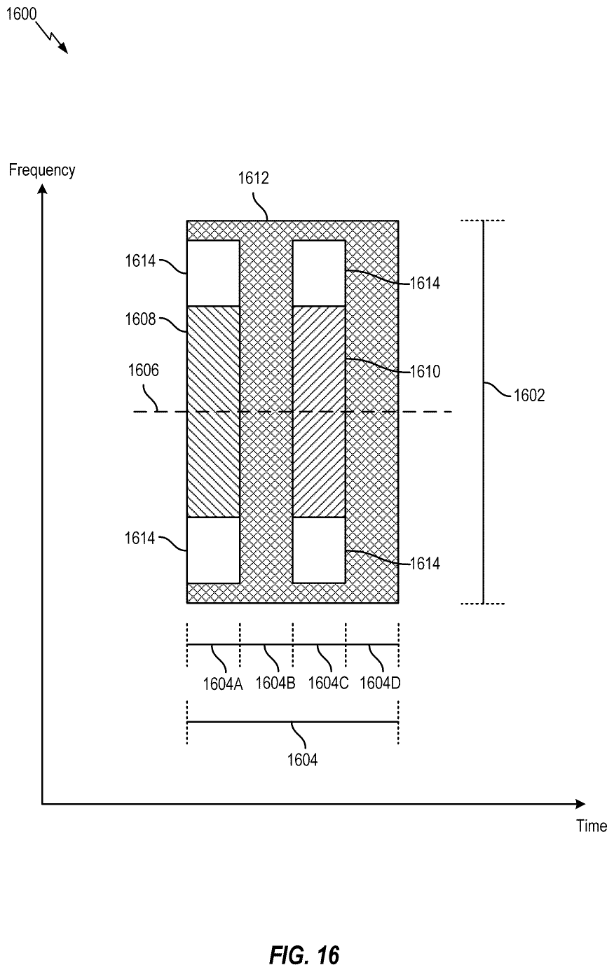

FIG. 16 illustrates an example SSB 1600 in time and frequency domains. In some examples, the SSB 1600 may implement aspects of or may be implemented by aspects of FIGS. 1-14B. For example, a network entity may broadcast the SSB 1600, and a UE may scan for and obtain the SSB 1600 to acquire synchronization information and/or other information to establish a communication link with the network entity as depicted and described with respect to FIG. 5. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3.

In some aspects, the SSB 1600 may include similar aspects as the SSB 500 depicted and described with respect to FIG. 5, but the SSB 1600 may represent a different shape (e.g., pattern of resources) than the SSB 500 (e.g., and the SSB 1500 depicted and described with respect to FIG. 15). For example, the SSB 1600 may occupy a frequency allocation 1602 (e.g., 22 RBs in the frequency domain, such that the frequency allocation 1602 includes 264 subcarriers and/or 264 REs) and four symbols 1604A-D (collectively symbols 1604) in the time domain. The SSB 1600 may have a center frequency 1606 that corresponds to a GSCN and the SSREF according to a synchronization raster (e.g., the synchronization raster provided above in Table 1). The SSB 1600 may include a PSS 1608, an SSS 1610, a PBCH 1612, and empty time-frequency resources 1614.

In the example of the SSB 1600, the PSS 1608 may occupy a first portion of the frequency allocation 1602 (e.g., 127 subcarriers and/or 127 REs) in the first symbol 1604A (e.g., symbol #n); the SSS 1610 may occupy the first portion of the frequency allocation 1602 (e.g., 127 subcarriers and/or 127 REs) in the third symbol 1604C (e.g., symbol #n+2); and the PBCH 1612 may occupy the frequency allocation 1602 in the second symbol 1604B (e.g., symbol #n+1) and the fourth symbol 1604D (e.g., symbol #n+3). Additionally, the PBCH 1612 may occupy a second portion of the frequency allocation 1602 (e.g., 12 subcarriers and/or 12 REs) at the top and at the bottom of the SSB 1600 in the first symbol 1604A and the third symbol 1604C.

In the example of the SSB 1600, the empty time-frequency resources 1614 may occupy a third portion of the frequency allocation 1602 (e.g., 57 subcarriers and/or 57 REs) above the PSS 1608 and below the PBCH 1612 in the first symbol 1604A and above the SSS 1610 and below the PBCH 1612 in the third symbol 1604C. The empty time-frequency resources 1614 may also occupy a fourth portion of the frequency allocation 1602 (e.g., 56 subcarriers and/or 56 REs) below the PSS 1608 and above the PBCH 1612 in the first symbol 1604A and below the SSS 1610 and above the PBCH 1612 in the third symbol 1604C.

Additionally or alternatively, the frequency allocation 1602 may include 20 RBs in the frequency domain, such that the frequency allocation 1602 includes 240 subcarriers and/or 240 REs. In such an example, the PSS 1608 and the SSS 1610 may occupy the first portion of the frequency allocation 1602 (e.g., 127 subcarriers and/or 127 REs) in the first symbol 1604A and the third symbol 1604C, respectively, and the PBCH 1612 may occupy the frequency allocation 1602 in the second symbol 1604B and the fourth symbol 1604D. However, the PBCH 1612 may occupy a fifth portion of the frequency allocation 1602 (e.g., 24 subcarriers and/or 24 REs) at the top and at the bottom of the SSB 1600 in the first symbol 1604A and the third symbol 1604C. Additionally, the empty time-frequency resources 1614 may occupy a sixth portion of the frequency allocation 1602 (e.g., 33 subcarriers and/or 33 REs) above the PSS 1608 and below the PBCH 1612 in the first symbol 1604A and above the SSS 1610 and below the PBCH 1612 in the third symbol 1604C. The empty time-frequency resources 1614 may also occupy a seventh portion of the frequency allocation 1602 (e.g., 32 subcarriers and/or 32 REs) below the PSS 1608 and above the PBCH 1612 in the first symbol 1604A and below the SSS 1610 and above the PBCH 1612 in the third symbol 1604C.

In some aspects, a pattern for the SSB 1600 (e.g., a shape of the SSB 1600) may be formed between a first set of resources (e.g., for the PSS 1608, the SSS 1610, and the PBCH 1612) and a second set of resources (e.g., for the empty time-frequency resources 1614), where the pattern for the SSB 1600 is different than a pattern of the SSB 500 (e.g., a shape of the SSB 500) depicted and described with respect to FIG. 5. For example, the PBCH 1612 may be distributed across each of the four symbols 1604A-D in the examples of the SSB 1600 described above, while the PBCH 512 is not transmitted in the first symbol 504A in the example of the SSB 500. Additionally, the portions of the SSB 1600 occupied by the empty time-frequency resources 1614 may be larger than the portions of the SSB 500 occupied by the empty time-frequency resources 514. For example, the portions of the frequency allocation 1602 that are occupied by the empty time-frequency resources 1614 for the SSB 1600 in the third symbol 1604C above and below the SSS 1610 may be larger than the corresponding portions of the frequency allocation 502 that are occupied by the empty time-frequency resources 514 for the SSB 500 in the third symbol 504C above and below the SSS 510.

Accordingly, these differences in the pattern for the SSB 1600 compared to the pattern of the SSB 500 (e.g., PBCH 1612 distributed across each of the four symbols 1604A-D, the larger portions occupied by the empty time-frequency resources 1614, etc.) may enable the UE to detect the SSB 1600 more successfully and/or reliably via an AI model (e.g., ML model) described herein compared to the pattern of the SSB 500. For example, the pattern for the SSB 1600 may not be formed by other types of signaling, such that the AI model is able to more successfully and/or reliably detect the SSB 1600 in spectral energy images based on detecting the pattern for the SSB 1600 compared to potentially falsely detecting the pattern for the SSB 500.

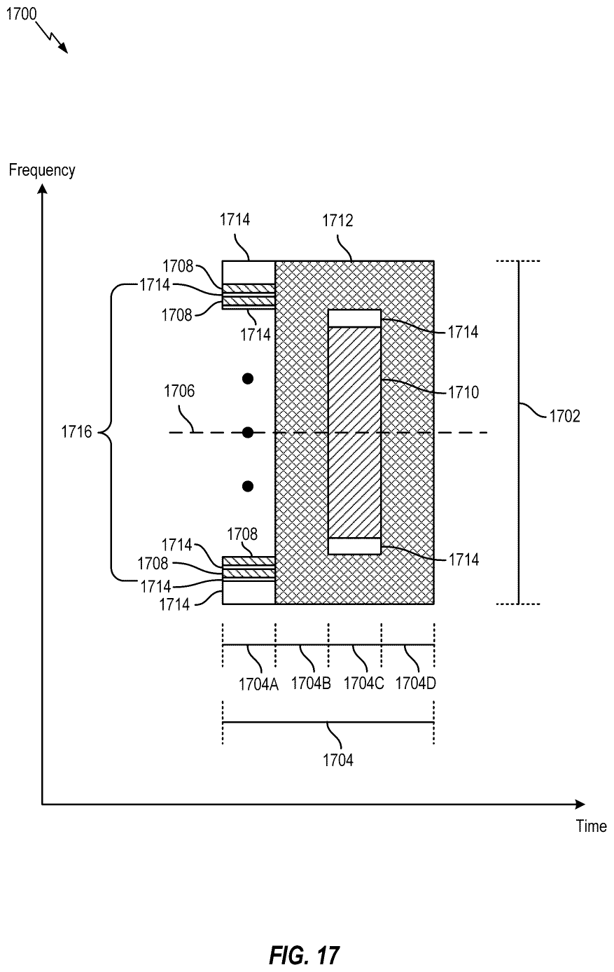

FIG. 17 illustrates an example SSB 1700 in time and frequency domains. In some examples, the SSB 1700 may implement aspects of or may be implemented by aspects of FIGS. 1-14B. For example, a network entity may broadcast the SSB 1700, and a UE may scan for and obtain the SSB 1700 to acquire synchronization information and/or other information to establish a communication link with the network entity as depicted and described with respect to FIG. 5. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3.

In some aspects, the SSB 1700 may include similar aspects as the SSB 500 depicted and described with respect to FIG. 5, but the SSB 1700 may represent a different shape (e.g., pattern of resources) than the SSB 500 (e.g., and the SSBs 1500 and 1600 depicted and described with respect to FIGS. 15 and 16, respectively). For example, the SSB 1700 may occupy a frequency allocation 1702 (e.g., 20 RBs in the frequency domain, such that the frequency allocation 1702 includes 240 subcarriers and/or 240 REs) and four symbols 1704A-D (collectively symbols 1704) in the time domain. The SSB 1700 may have a center frequency 1706 that corresponds to a GSCN and the SSREF according to a synchronization raster (e.g., the synchronization raster provided above in Table 1). The SSB 1700 may include a PSS 1708, an SSS 1710, a PBCH 1712, and empty time-frequency resources 1714.

In the example of the SSB 1700, the PSS 1708 and the empty time-frequency resources 1714 may occupy different portions of the frequency allocation 1702 in the first symbol 1704A (e.g., symbol #n). For example, the empty time-frequency resources 1714 may occupy a first portion of the frequency allocation 1702 (e.g., 24 subcarriers and/or 24 REs) at the top of the SSB 1700 in the first symbol 1704A and at the bottom of the SSB 1700 in the first symbol 1704A. In between the two regions of the first portions, allocations for the PSS 1708 and the empty time-frequency resources 1714 may alternate (e.g., the allocations for the PSS 1708 and the empty time-frequency resources 1714 are interlaced) for a section 1716 of the frequency allocation 1702 in the first symbol 1704A. For example, each portion of the PSS 1708 in the section 1716 may include a second portion of the frequency allocation 1702 (e.g., eight subcarriers and/or eight REs) except for a last instance of the PSS 1708 at the bottom of the section 1716, which may include a third portion of the frequency allocation 1702 (e.g., seven subcarriers and/or seven REs). Similarly, each portion of the empty time-frequency resources 1714 in the section 1716 may include a fourth portion of the frequency allocation 1702 (e.g., four subcarriers and/or four REs) except for a last instance of the empty time-frequency resources 1714 at the bottom of the section 1716, which may include a fifth portion of the frequency allocation 1702 (e.g., five subcarriers and/or five REs).

In some aspects, the section 1716 may occupy 16 RBs (e.g., 192 subcarriers and/or 192 REs) of the frequency allocation 1702, where each RB of the 16 RBs includes the second portion and the fourth portion of the frequency allocation 1702, except for a last RB of the 16 RBs at the bottom of the section 1716, which may include the third portion and the fifth portion of the frequency allocation 1702.

Additionally, in the example of the SSB 1700, the SSS 1710 may occupy a sixth portion of the frequency allocation 1702 (e.g., 127 subcarriers and/or 127 REs) in the third symbol 1704C (e.g., symbol #n+2). The PBCH 1712 may occupy the frequency allocation 1702 in the second symbol 1704B (e.g., symbol #n+1) and the fourth symbol 1704D (e.g., symbol #n+3). The PBCH 1712 may also occupy a seventh portion of the frequency allocation 1702 (e.g., 48 subcarriers and/or 48 REs) at the top and at the bottom of the SSB 1700 in the third symbol 1704C. The empty time-frequency resources 1714 may occupy an eighth portion of the frequency allocation 1702 (e.g., nine subcarriers and/or nine REs) above the SSS 1710 in the third symbol 1704C and may occupy a ninth portion of the frequency allocation 1702 (e.g., eight subcarriers and/or eight REs) below the SSS 1710 in the third symbol 1704C.

In some aspects, a pattern for the SSB 1700 (e.g., a shape of the SSB 1700) may be formed between a first set of resources (e.g., for the PSS 1708, the SSS 1710, and the PBCH 1712) and a second set of resources (e.g., for the empty time-frequency resources 1714), where the pattern for the SSB 1700 is different than a pattern of the SSB 500 (e.g., a shape of the SSB 500) depicted and described with respect to FIG. 5. For example, the section 1716 in the first symbol 1704A that includes the interlaced pattern between the PSS 1708 and the empty time-frequency resources 1714 for the SSB 1700 may be different than how the PSS 508 and the empty time-frequency resources 514 are distributed in the first symbol 504A for the SSB 500. In the example of the SSB 1700, the PSS 1708 and the empty time-frequency resources 1714 may occupy different subcarriers and/or REs of a same RB for one or more RBs in the section 1716, but the interlaced pattern between the PSS 1708 and the empty time-frequency resources 1714 may also or alternatively occur between one or more RBs. In some aspects, this distribution of the PSS 1708 and the empty time-frequency resources 1714 in different subcarriers and/or REs of a same RB may not be seen and/or generated by other signals or waveforms. Additionally, a different pattern than the interlaced pattern between the PSS 1708 and the empty time-frequency resources 1714 in the section 1716 may be used within a same RB and/or across one or more RBs, where the different pattern also may not be seen and/or generated by other signals or waveforms.

Accordingly, these differences in the pattern for the SSB 1700 compared to the pattern of the SSB 500 (e.g., the pattern between the PSS 1708 and the empty time-frequency resources 1714 in the first symbol 1704A, such as the interlaced pattern within different RBs) may enable the UE to detect the SSB 1700 more successfully and/or reliably via an AI model (e.g., ML model) described herein compared to the pattern of the SSB 500. For example, the pattern for the SSB 1700 may not be formed by other types of signaling, such that the AI model is able to more successfully and/or reliably detect the SSB 1700 in spectral energy images based on detecting the pattern for the SSB 1700 compared to potentially falsely detecting the pattern for the SSB 500.

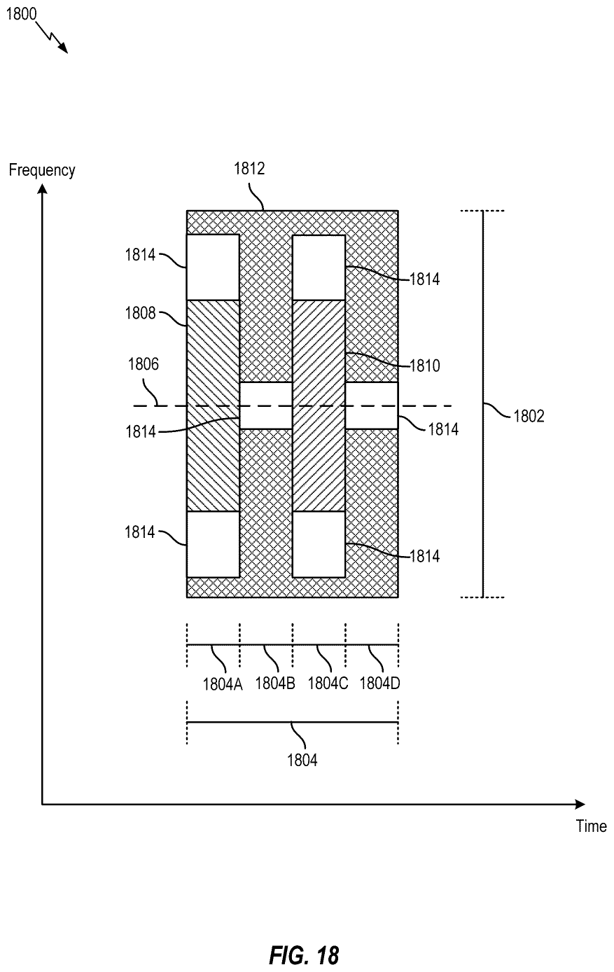

FIG. 18 illustrates an example SSB 1800 in time and frequency domains. In some examples, the SSB 1800 may implement aspects of or may be implemented by aspects of FIGS. 1-14B. For example, a network entity may broadcast the SSB 1800, and a UE may scan for and obtain the SSB 1800 to acquire synchronization information and/or other information to establish a communication link with the network entity as depicted and described with respect to FIG. 5. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3.

In some aspects, the SSB 1800 may include similar aspects as the SSB 500 depicted and described with respect to FIG. 5, but the SSB 1800 may represent a different shape (e.g., pattern of resources) than the SSB 500 (e.g., and the SSBs 1500, 1600, and 1800 depicted and described with respect to FIGS. 15, 16, and 17, respectively). For example, the SSB 1800 may occupy a frequency allocation 1802 (e.g., 24 RBs in the frequency domain, such that the frequency allocation 1802 includes 288 subcarriers and/or 288 REs) and four symbols 1804A-D (collectively symbols 1804) in the time domain. The SSB 1800 may have a center frequency 1806 that corresponds to a GSCN and the SSREF according to a synchronization raster (e.g., the synchronization raster provided above in Table 1). The SSB 1800 may include a PSS 1808, an SSS 1810, a PBCH 1812, and empty time-frequency resources 1814.

The PSS 1808 may occupy a first portion of the frequency allocation 1802 (e.g., 127 subcarriers and/or 127 REs) in the first symbol 1804A (e.g., symbol #n); the SSS 1810 may occupy the first portion of the frequency allocation 1802 (e.g., 127 subcarriers and/or 127 REs) in the third symbol 1804C (e.g., symbol #n+2); and the PBCH 1812 may occupy a second portion of the frequency allocation 1802 (e.g., 120 subcarriers and/or 120 REs) at the top and at the bottom of the second symbol 1804B (e.g., symbol #n+1) and the fourth symbol 1804D (e.g., symbol #n+3). Additionally, the PBCH 1812 may occupy a third portion of the frequency allocation 1802 (e.g., 24 subcarriers and/or 24 REs) at the top and at the bottom of the SSB 1800 in the first symbol 1804A and the third symbol 1804C.

In the example of the SSB 1800, the empty time-frequency resources 1814 may occupy a fourth portion of the frequency allocation 1802 (e.g., 57 subcarriers and/or 57 REs) above the PSS 1808 in the first symbol 1804A and above the SSS 1810 in the third symbol 1804C. Additionally, the empty time-frequency resources 1814 may occupy a fifth portion of the frequency allocation 1802 (e.g., 56 subcarriers and/or 56 REs) below the PSS 1808 in the first symbol 1804A and below the SSS 1810 in the third symbol 1804C. The empty time-frequency resources 1814 may also occupy a sixth portion of the frequency allocation 1802 (e.g., 48 subcarriers and/or 48 REs) between the second portions of the frequency allocation 1802 occupied by the PBCH 1812 at the top and at the bottom of the second symbol 1804B and the fourth symbol 1804D.

In some aspects, a pattern for the SSB 1800 (e.g., a shape of the SSB 1800) may be formed between a first set of resources (e.g., for the PSS 1808, the SSS 1810, and the PBCH 1812) and a second set of resources (e.g., for the empty time-frequency resources 1814), where the pattern for the SSB 1800 is different than a pattern of the SSB 500 (e.g., a shape of the SSB 500) depicted and described with respect to FIG. 5. For example, the PBCH 1812 may be distributed across each of the four symbols 1804A-D in the examples of the SSB 1800 described above, while the PBCH 512 is not transmitted in the first symbol 504A in the example of the SSB 500. Additionally, the portions of the SSB 1800 occupied by the empty time-frequency resources 1814 may be larger than the portions of the SSB 500 occupied by the empty time-frequency resources 514. For example, the portions of the frequency allocation 1802 that are occupied by the empty time-frequency resources 1814 for the SSB 1800 in the third symbol 1804C above and below the SSS 1810 may be larger than the corresponding portions of the frequency allocation 502 that are occupied by the empty time-frequency resources 514 for the SSB 500 in the third symbol 504C above and below the SSS 510. Additionally, the empty time-frequency resources 1814 may be distributed across each of the four symbols 1804A-D, such that the empty time-frequency resources 1814 occupy portions of the frequency allocation 1802 in the second symbol 1804B and the fourth symbol 1804D for the SSB 1800, while the empty time-frequency resources 514 do not occupy any portion of the frequency allocation 502 in the second symbol 504B or the fourth symbol 504D for the SSB 500.

Accordingly, these differences in the pattern for the SSB 1800 compared to the pattern of the SSB 500 (e.g., PBCH 1812 distributed across each of the four symbols 1804A-D, the larger portions occupied by the empty time-frequency resources 1814, the empty time-frequency resources 1814 distributed across each of the four symbols 1804A-D, etc.) may enable the UE to detect the SSB 1800 more successfully and/or reliably via an AI model (e.g., ML model) described herein compared to the pattern of the SSB 500. For example, the pattern for the SSB 1800 may not be formed by other types of signaling, such that the AI model is able to more successfully and/or reliably detect the SSB 1800 in spectral energy images based on detecting the pattern for the SSB 1800 compared to potentially falsely detecting the pattern for the SSB 500.

Note that the SSBs 1500, 1600, 1700, and 1800 are merely example structures for synchronization signaling, and other structures (e.g., different time and/or frequency domain arrangements for the PSS, the SSS, the PBCH and/or the empty time-frequency resources) may be used in addition to or instead of the structure depicted for the SSBs 1500, 1600, 1700, and 1800. For example, an SSB may use a generalized pattern (e.g., a QR code style) based on the patterns depicted and described with respect to the SSBs 1500, 1600, 1700, and 1800 to enhance detectability of the SSB and/or to encode information in the SSB.

### Example Operations of AI-based SSB Scanning and Model Training

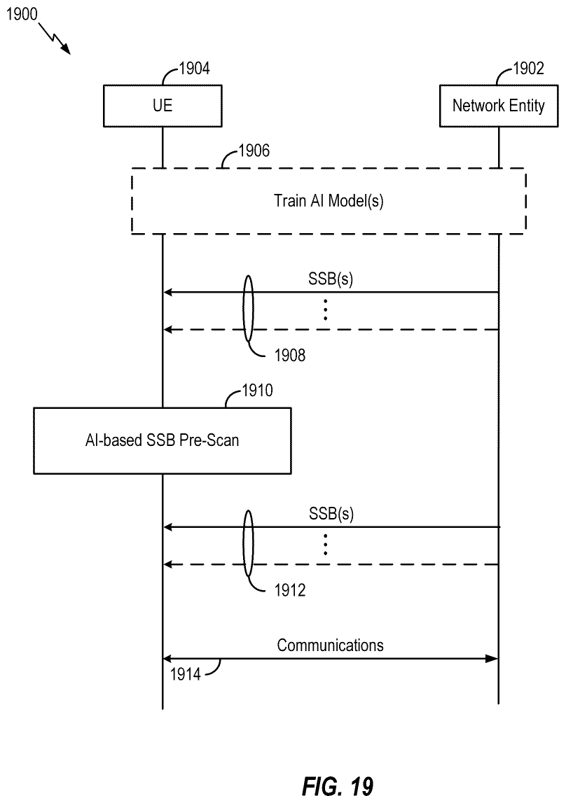

FIG. 19 depicts a process flow 1900 for communications in a system between a network entity 1902 and a UE 1904. In some aspects, the network entity 1902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1904 may be an example of the UE 104 depicted and described with respect to FIG. 1 or the UE 304 depicted and described with respect to FIG. 3. However, in other aspects, UE 1904 may be another type of wireless communications device and network entity 1902 may be another type of network entity or network node, such as those described herein.

At 1906, the UE 1904 and/or the network entity 1902 may train an AI model, for example, as described herein with respect to FIG. 12. In some cases, the UE 1904 and/or the network entity 1902 may perform model training using training data collected from the UE 1904 performing SSB scanning with or without AI. In certain cases, the UE 1904 and/or the network entity 1902 may obtain training data from a data source, such as the data source 606 of FIG. 6. In certain aspects, the network entity 1902 may send, to the UE 1904, the trained AI model and/or information to reproduce the AI model. Note that the UE 1904 and/or the network entity 1902 may perform online model training and/or batched model training as described above. Thus, the UE 1904 and/or the network entity 1902 may perform the AI model training at various times.

At 1908, the UE 1904 may monitor for SSB(s) in one or more frequency bandwidths, for example, as described herein with respect to FIGS. 9 and 10. For example, the UE 1904 may monitor at least a first frequency bandwidth across a set of time windows (e.g., for the SSB(s)). The network entity 1902 may broadcast the SSBs at certain frequencies and transmission occasions, for example, in the synchronization raster as described herein with respect to FIG. 5. The UE 1904 may generate spectral energy images indicative of the spectral energy observed in the frequency bandwidths. In some cases, the UE 1904 may receive SSB(s) while monitoring for radio waves in the frequency bandwidths.

At 1910, the UE 1904 may perform an AI-based SSB pre-scanning operation, for example, as described herein with respect to FIGS. 9-11. For example, the UE 1904 may obtain GSCN candidates from an AI model (e.g., the AI model 1022 and/or an ML model). The GSCN candidates may correspond to the center frequencies of possible SSBs.

At 1912, the UE 1904 may receive SSBs from the network entity 1902. The UE 1904 may monitor for the SSBs at the GSCN candidates obtained at 1910, and some of the GSCN candidates may be an actual center frequency of an SSB. In some aspects, the UE may identify an SSB centered at a GSCN (e.g., of the GSCN candidates) in the first frequency bandwidth. The UE 1904 may perform time and/or frequency synchronization using the received SSBs.

In some aspects, the UE 1904 may monitor for and receive the SSBs from the network entity 1902 based on the AI model described above, where the AI model is trained to detect specific feature(s) and/or a shape of the SSBs based on the generated spectral energy images. For example, an SSB may occupy a first set of resources (e.g., for a PSS, SSS, PBCH, etc.) and may not occupy a second set of resources (e.g., for empty time-frequency resources) of a plurality of subcarriers in a frequency domain (e.g., the frequency allocations depicted and described with respect to FIGS. 15-18) and a plurality of symbols in a time domain (e.g., the four symbols depicted and described with respect to FIGS. 15-18), where each of the plurality of symbols includes at least one resource of the first set of resources. In some aspects, a transmission power of the SSB may be different and/or varied across the first set of resources.

Accordingly, the first set of resources and the second set of resources may form a pattern (e.g., as depicted and described with respect to FIGS. 15-18), and the pattern may be configured for enhanced detectability by the AI model configured to detect SSBs. In some aspects, the plurality of subcarriers and the plurality of symbols may form a plurality of RBs, and at least one RB of the plurality of RBs may include at least one first resource of the first set of resources and at least one second resource of the second set of resources. For example, the at least one first resource may be interlaced with the at least one second resource (e.g., as depicted and described with respect to FIG. 17) in the at least one RB. In some aspects, the SSB may include a PSS that includes the at least one RB (e.g., via the at least one first resource of the first set of resources in the RB).

In some aspects, the SSB may include a PBCH that occupies at least two non-contiguous (e.g., in frequency) sets of resources of the first set of resources in a symbol of the plurality of symbols (e.g., as depicted and described with respect to FIGS. 16-18). Additionally or alternatively, the SSB may include a PBCH that occupies at least a portion of each of the plurality of symbols (e.g., as depicted and described with respect to FIGS. 16 and 18). Additionally or alternatively, the SSB may include an SSS that occupies a symbol of the plurality of symbols and may include a PBCH that does not occupy the symbol (e.g., as depicted and described with respect to FIG. 15). Additionally or alternatively, the second set of resources may include five or more non-contiguous sets of resources (e.g., as depicted and described with respect to FIGS. 17 and 18).

At 1914, the UE 1904 may perform cell acquisition and establish a communication link with the network entity 1902. For example, the received SSBs may carry certain system information that enables the UE 1904 to establish the communication link with the network entity 1902. Subsequently, the UE 1904 and the network entity 1902 may communicate based on the received SSB(s).

Note that the process flow illustrated in FIG. 19 is an example of synchronization signal scanning, and aspects of the present disclosure may be applied to an AI-based synchronization signal scanning. Note that the process flow illustrated in FIG. 19 is described herein to facilitate an understanding of AI-based synchronization signal scanning based on detecting shapes (e.g., patterns) of SSBs, and aspects of the present disclosure may be performed in various manners via alternative or additional signaling and/or operations. In certain aspects, the operations and/or signaling of FIG. 19 may occur in an order different from that described or depicted, and various actions, operations, and/or signaling may be added, omitted, or combined.

### Example Operations of a User Equipment

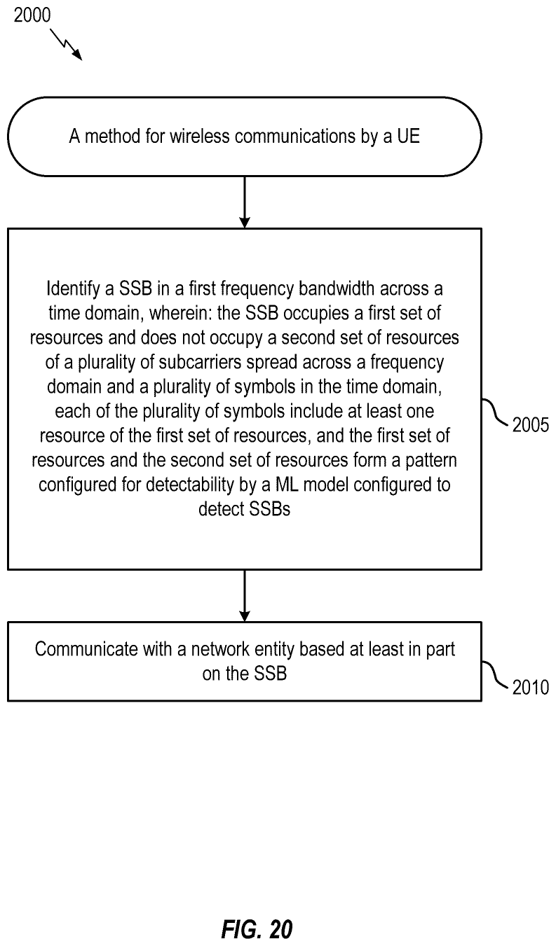

FIG. 20 shows a method 2000 for wireless communications by a UE, such as UE 104 of FIG. 1 or UE 304 of FIG. 3.

Method 2000 begins at block 2005 with identifying a SSB (e.g., the SSBs depicted and described with respect to FIGS. 15-18) in a first frequency bandwidth across a time domain, wherein: the SSB occupies a first set of resources (e.g., time-frequency resources for a PSS, SSS, PBCH, etc. as depicted and described with respect to FIGS. 15-18) and does not occupy a second set of resources (e.g., time-frequency resources for empty time-frequency resources as depicted and described with respect to FIGS. 15-18) of a plurality of subcarriers spread across a frequency domain and a plurality of symbols in the time domain, each of the plurality of symbols include at least one resource of the first set of resources, and the first set of resources and the second set of resources form a pattern configured for detectability by a ML model configured to detect SSBs (e.g., the AI model as described herein with respect to FIG. 12).

Method 2000 then proceeds to block 2010 with communicating with a network entity based at least in part on the SSB (e.g., the received SSBs may carry certain system information and synchronization signaling that enables a communication link with the network entity, such as via a PSS, SSS, PBCH, etc. as depicted and described with respect to FIGS. 15-18).

In some aspects, the plurality of subcarriers and the plurality of symbols form a plurality of RBs; and at least one RB of the plurality of RBs comprises at least one first resource of the first set of resources and at least one second resource of the second set of resources.

In some aspects, the at least one first resource is interlaced with the at least one second resource in the at least one RB (e.g., as depicted and described with respect to FIG. 17).

In some aspects, the SSB comprises a PSS comprising the at least one RB.

In some aspects, the SSB comprises a PBCH that occupies at least two non-contiguous in frequency sets of resources of the first set of resources in a symbol of the plurality of symbols (e.g., as depicted and described with respect to FIGS. 16-18).

In some aspects, a transmission power of the SSB is different across the first set of resources.

In some aspects, the SSB comprises a PBCH that occupies at least a portion of each of the plurality of symbols (e.g., as depicted and described with respect to FIGS. 16 and 18).

In some aspects, the SSB comprises: a SSS that occupies a symbol of the plurality of symbols; and a PBCH that does not occupy the symbol (e.g., as depicted and described with respect to FIG. 15).

In some aspects, the second set of resources comprises five or more non-contiguous sets of resources (e.g., as depicted and described with respect to FIGS. 17 and 18).

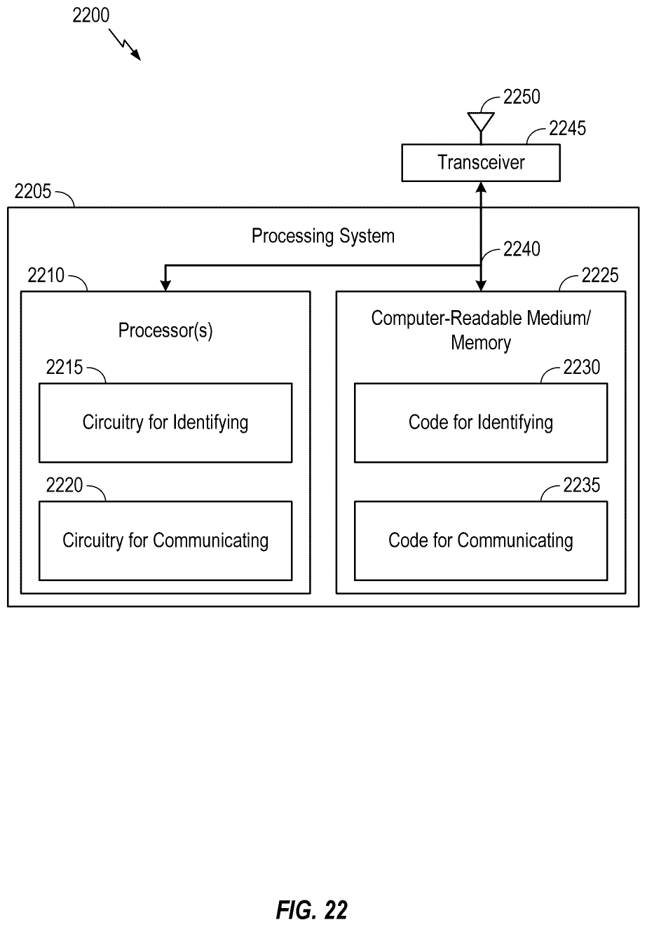

In some aspect, method 2000, or any aspect related to it, may be performed by an apparatus, such as communications device 2200 of FIG. 22, which includes various components operable, configured, or adapted to perform the method 2000. Communications device 2200 is described below in further detail.

Note that FIG. 20 is just one example of a method, and other methods including fewer, additional, or alternative operations are possible consistent with this disclosure.

In certain aspects, method 2000 may be performed by the apparatus to realize one or more technical effects or solutions to the aforementioned technical problem(s). For example, detectability of SSBs may be improved by an AI model based on the method 2000, thereby providing a technical benefit of improved SSB detection. For example, an SSB waveform shape may be configured to differ from other types of communications. In certain aspects, an SSB waveform shape may occupy one or more resources (e.g., time-frequency resources) and not occupy one or more resources to form a pattern of occupied and not occupied resources that differs from other types of communications. For example, the pattern may include blocks of occupied resources interspersed (e.g., interleaved) with blocks of unoccupied resources in a relatively unique pattern. In some aspects, the AI model may be trained and/or configured to detect certain features, such as a shape (e.g., pattern) of an SSB to enable the improved accuracy of the SSB detection (e.g., reduce false alarms and/or miss detections).

### Example Operations of a Network Entity

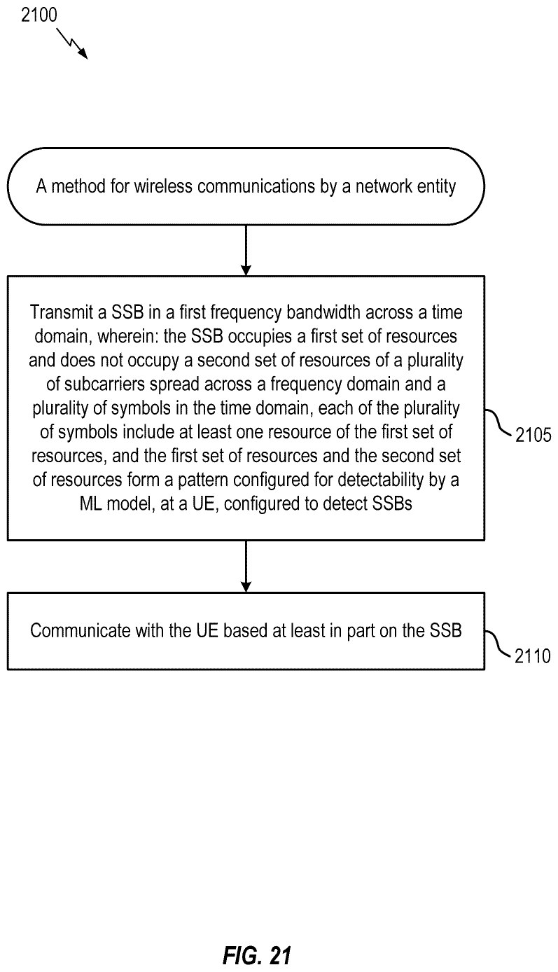

FIG. 21 shows a method 2100 for wireless communications by a network entity, such as BS 102 of FIG. 1, a first network entity 300 or second network entity 302 of FIG. 3, or a disaggregated base station as discussed with respect to FIG. 2.

Method 2100 begins at block 2105 with transmitting a SSB (e.g., the SSBs depicted and described with respect to FIGS. 15-18) in a first frequency bandwidth across a time domain, wherein: the SSB occupies a first set of resources (e.g., time-frequency resources for a PSS, SSS, PBCH, etc. as depicted and described with respect to FIGS. 15-18) and does not occupy a second set of resources (e.g., time-frequency resources for empty time-frequency resources as depicted and described with respect to FIGS. 15-18) of a plurality of subcarriers spread across a frequency domain and a plurality of symbols in the time domain, each of the plurality of symbols include at least one resource of the first set of resources, and the first set of resources and the second set of resources form a pattern configured for detectability by a ML model, at a UE, configured to detect SSBs (e.g., the AI model as described herein with respect to FIG. 12).

Method 2100 then proceeds to block 2110 with communicating with the UE based at least in part on the SSB (e.g., the received SSBs may carry certain system information and synchronization signaling that enables a communication link with the network entity, such as via a PSS, SSS, PBCH, etc. as depicted and described with respect to FIGS. 15-18).

In some aspects, the plurality of subcarriers and the plurality of symbols form a plurality of RBs; and at least one RB of the plurality of RBs comprises at least one first resource of the first set of resources and at least one second resource of the second set of resources.

In some aspects, the at least one first resource is interlaced with the at least one second resource in the at least one RB (e.g., as depicted and described with respect to FIG. 17).

In some aspects, the SSB comprises a PSS comprising the at least one RB.

In some aspects, the SSB comprises a PBCH that occupies at least two non-contiguous in frequency sets of resources of the first set of resources in a symbol of the plurality of symbols (e.g., as depicted and described with respect to FIGS. 16-18).

In some aspects, a transmission power of the SSB is varied across the first set of resources.

In some aspects, the SSB comprises a PBCH that occupies at least a portion of each of the plurality of symbols (e.g., as depicted and described with respect to FIGS. 16 and 18).

In some aspects, the SSB comprises: a SSS that occupies a symbol of the plurality of symbols; and a PBCH that does not occupy the symbol (e.g., as depicted and described with respect to FIG. 15).

In some aspects, the second set of resources comprises five or more non-contiguous sets of resources (e.g., as depicted and described with respect to FIGS. 17 and 18).

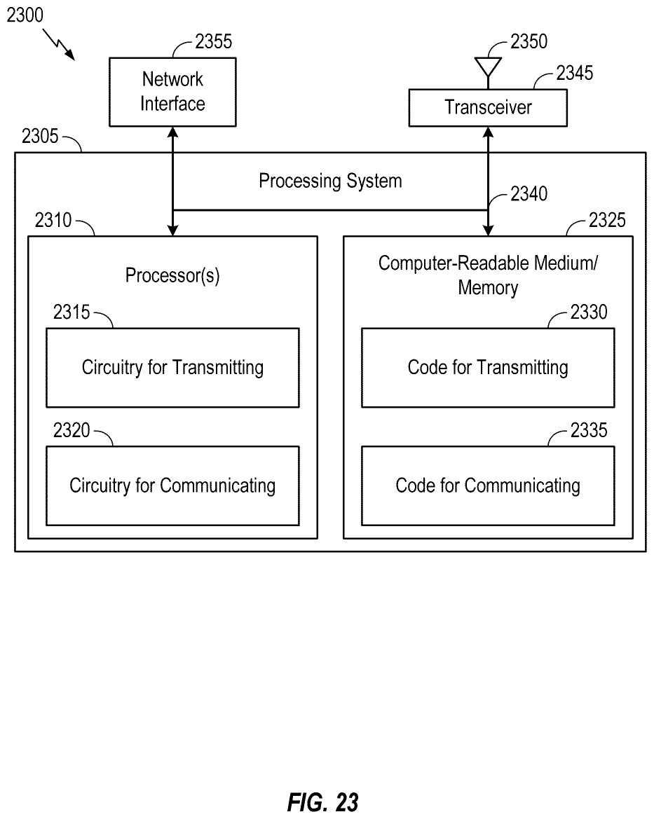

In some aspect, method 2100, or any aspect related to it, may be performed by an apparatus, such as communications device 2300 of FIG. 23, which includes various components operable, configured, or adapted to perform the method 2100. Communications device 2300 is described below in further detail.

Note that FIG. 21 is just one example of a method, and other methods including fewer, additional, or alternative operations are possible consistent with this disclosure.

In certain aspects, method 2100 may be performed by the apparatus to realize one or more technical effects or solutions to the aforementioned technical problem(s). For example, detectability of SSBs may be improved by an AI model based on the method 2100, thereby providing a technical benefit of improved SSB detection. For example, an SSB waveform shape may be configured to differ from other types of communications. In certain aspects, an SSB waveform shape may occupy one or more resources (e.g., time-frequency resources) and not occupy one or more resources to form a pattern of occupied and not occupied resources that differs from other types of communications. For example, the pattern may include blocks of occupied resources interspersed (e.g., interleaved) with blocks of unoccupied resources in a relatively unique pattern. In some aspects, the AI model may be trained and/or configured to detect certain features, such as a shape (e.g., pattern) of an SSB to enable the improved accuracy of the SSB detection (e.g., reduce false alarms and/or miss detections).

### Example Communications Devices

FIG. 22 depicts aspects of an example communications device 2200 configured for wireless communications. In some aspects, communications device 2200 is a user equipment, such as UE 104 described above with respect to FIG. 1 or UE 304 described with respect to FIG. 3.

The communications device 2200 includes a processing system 2205 coupled to a transceiver 2245 (e.g., a transmitter and/or a receiver). The transceiver 2245 is configured to transmit and receive signals for the communications device 2200 via an antenna 2250, such as the various signals as described herein. The processing system 2205 may be configured to perform processing functions for the communications device 2200, including processing signals received and/or to be transmitted by the communications device 2200.

The processing system 2205 includes one or more processors 2210 and a computer-readable medium/memory 2225. In various aspects, the one or more processors 2210 may be representative of the one or more processors 318 described with respect to FIG. 3. The one or more processors 2210 are coupled to a computer-readable medium/memory 2225 via a bus 2240. In some aspects, the computer-readable medium/memory 2225 may be representative of the one or more memories 320 described with respect to FIG. 3. The computer-readable medium/memory 2225 is a non-transitory computer-readable medium/memory. In certain aspects, the computer-readable medium/memory 2225 is configured to store instructions (e.g., computer-executable code), that when executed by the one or more processors 2210, cause the one or more processors 2210 to perform the method 2000 described with respect to FIG. 20, or any aspect related to it, including any operations described in relation to FIG. 20. Note that reference to a processor performing a function of communications device 2200 may include one or more processors performing that function of communications device 2200, such as in a distributed fashion.

In the depicted example, computer-readable medium/memory 2225 stores code (e.g., executable instructions), including code for identifying 2230 and code for communicating 2235. Processing of the code 2230 and 2235 may enable and cause the communications device 2200 to perform the method 2000 described with respect to FIG. 20, or any aspect related to it. For example, in some aspects, code for identifying 2230 includes code for identifying a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model configured to detect SSBs. In some aspects, code for communicating 2235 includes code for communicating with a network entity based at least in part on the SSB.

The one or more processors 2210 include circuitry configured to implement (e.g., execute) the code stored in the computer-readable medium/memory 2225, including circuitry for identifying 2215 and circuitry for communicating 2220. Processing with circuitry 2215 and 2220 may enable and cause the communications device 2200 to perform the method 2000 described with respect to FIG. 20, or any aspect related to it. For example, in some aspects, circuitry for identifying 2215 includes circuitry for identifying a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model configured to detect SSBs. In some aspects, circuitry for communicating 2220 includes circuitry for communicating with a network entity based at least in part on the SSB.

More generally, means for communicating, transmitting, sending or outputting for transmission may include the one or more transceivers 324, one or more antenna 322 and/or processing system 316 of the UE 304 illustrated in FIG. 3, transceiver 2245 and/or antenna 2250 of the communications device 2200 in FIG. 22, and/or one or more processors 2210 of the communications device 2200 in FIG. 22. Means for communicating, receiving or obtaining may include the one or more transceivers 324, one or more antennas 322, and/or processing system 316 of the UE 304 illustrated in FIG. 3, transceiver 2245 and/or antenna 2250 of the communications device 2200 in FIG. 22, and/or one or more processors 2210 of the communications device 2200 in FIG. 22.

FIG. 23 depicts aspects of an example communications device configured for wireless communications. In some aspects, communications device 2300 is a network entity, such as BS 102 of FIG. 1, first network entity 300 or second network entity 302 of FIG. 3, or a disaggregated base station as discussed with respect to FIG. 2.

The communications device 2300 includes a processing system 2305 coupled to a transceiver 2345 (e.g., a transmitter and/or a receiver) and/or a network interface 2355. The transceiver 2345 is configured to transmit and receive signals for the communications device 2300 via an antenna 2350, such as the various signals as described herein. The network interface 2355 is configured to obtain and send signals for the communications device 2300 via communications link(s), such as a backhaul link, midhaul link, and/or fronthaul link as described herein, such as with respect to FIG. 2. The processing system 2305 may be configured to perform processing functions for the communications device 2300, including processing signals received and/or to be transmitted by the communications device 2300.

The processing system 2305 includes one or more processors 2310 and a computer-readable medium/memory 2325. In various aspects, one or more processors 2310 may be representative of the one or more processors 308, as described with respect to FIG. 3. The one or more processors 2310 are coupled to the computer-readable medium/memory 2325 via a bus 2340. In certain aspects, the computer-readable medium/memory 2325 is configured to store instructions (e.g., computer-executable code), including code 2330 and 2335, that when executed by the one or more processors 2310, cause the one or more processors 2310 to perform the method 2100 described with respect to FIG. 21, or any aspect related to it, including any operations described in relation to FIG. 21. The computer-readable medium/memory 2325 is a non-transitory computer-readable medium/memory. Note that reference to a processor of communications device 2300 performing a function may include one or more processors of communications device 2300 performing that function, such as in a distributed fashion.

In the depicted example, the computer-readable medium/memory 2325 stores code (e.g., executable instructions), including code for transmitting 2330 and code for communicating 2335. Processing of the code 2330 and 2335 may enable and cause the communications device 2300 to perform the method 2100 described with respect to FIG. 21, or any aspect related to it. For example, in some aspects, code for transmitting 2330 includes code for transmitting a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model, at a UE, configured to detect SSBs. In some aspects, code for communicating 2335 includes code for communicating with the UE based at least in part on the SSB.

The one or more processors 2310 include circuitry configured to implement (e.g., execute) the code stored in the computer-readable medium/memory 2325, including circuitry for transmitting 2315 and circuitry for communicating 2320. Processing with circuitry 2315 and 2320 may enable and cause the communications device 2300 to perform the method 2100 described with respect to FIG. 21, or any aspect related to it. For example, in some aspects, circuitry for transmitting 2315 includes circuitry for transmitting a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model, at a UE, configured to detect SSBs. In some aspects, circuitry for communicating 2320 includes circuitry for communicating with the UE based at least in part on the SSB.

Various components of the communications device 2300 may provide means for performing the method 2100 described with respect to FIG. 21, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 2345, antenna 2350, and/or network interface 2355 of the communications device 2300 in FIG. 23, and/or one or more processors 2310 of the communications device 2300 in FIG. 23. Means for communicating, receiving or obtaining may include the one or more transceivers 312, one or more antennas 314, and/or processing system 306 of the first network entity 300 or the second network entity 302 illustrated in FIG. 3, transceiver 2345, antenna 2350, and/or network interface 2355 of the communications device 2300 in FIG. 23, and/or one or more processors 2310 of the communications device 2300 in FIG. 23.

### Example Clauses

Implementation examples are described in the following numbered clauses:

Clause 1: A method for wireless communications by a UE comprising: identifying a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model configured to detect SSBs; and communicating with a network entity based at least in part on the SSB.

Clause 2: The method of Clause 1, wherein: the plurality of subcarriers and the plurality of symbols form a plurality of RBs; and at least one RB of the plurality of RBs comprises at least one first resource of the first set of resources and at least one second resource of the second set of resources.

Clause 3: The method of Clause 2, wherein the at least one first resource is interlaced with the at least one second resource in the at least one RB.

Clause 4: The method of Clause 3, wherein the SSB comprises a PSS comprising the at least one RB.

Clause 5: The method of any one of Clauses 1-4, wherein the SSB comprises a PBCH that occupies at least two non-contiguous in frequency sets of resources of the first set of resources in a symbol of the plurality of symbols.

Clause 6: The method of any one of Clauses 1-5, wherein a transmission power of the SSB is different across the first set of resources.

Clause 7: The method of any one of Clauses 1-6, wherein the SSB comprises a PBCH that occupies at least a portion of each of the plurality of symbols.

Clause 8: The method of any one of Clauses 1-7, wherein the SSB comprises: a SSS that occupies a symbol of the plurality of symbols; and a PBCH that does not occupy the symbol.

Clause 9: The method of any one of Clauses 1-8, wherein the second set of resources comprises five or more non-contiguous sets of resources.

Clause 10: A method for wireless communications by a network entity comprising: transmitting a SSB in a first frequency bandwidth across a time domain, wherein: the SSB occupies a first set of resources and does not occupy a second set of resources of a plurality of subcarriers spread across a frequency domain and a plurality of symbols in the time domain, each of the plurality of symbols include at least one resource of the first set of resources, and the first set of resources and the second set of resources form a pattern configured for detectability by a ML model, at a UE, configured to detect SSBs; and communicating with the UE based at least in part on the SSB.

Clause 11: The method of Clause 10, wherein: the plurality of subcarriers and the plurality of symbols form a plurality of RBs; and at least one RB of the plurality of RBs comprises at least one first resource of the first set of resources and at least one second resource of the second set of resources.

Clause 12: The method of Clause 11, wherein the at least one first resource is interlaced with the at least one second resource in the at least one RB.

Clause 13: The method of Clause 12, wherein the SSB comprises a PSS comprising the at least one RB.

Clause 14: The method of any one of Clauses 10-13, wherein the SSB comprises a PBCH that occupies at least two non-contiguous in frequency sets of resources of the first set of resources in a symbol of the plurality of symbols.

Clause 15: The method of any one of Clauses 10-14, wherein a transmission power of the SSB is varied across the first set of resources.

Clause 16: The method of any one of Clauses 10-15, wherein the SSB comprises a PBCH that occupies at least a portion of each of the plurality of symbols.

Clause 17: The method of any one of Clauses 10-16, wherein the SSB comprises: a SSS that occupies a symbol of the plurality of symbols; and a PBCH that does not occupy the symbol.

Clause 18: The method of any one of Clauses 10-17, wherein the second set of resources comprises five or more non-contiguous sets of resources.

Clause 19: One or more apparatuses, comprising: one or more memories comprising executable instructions; and one or more processors configured to execute the executable instructions and cause the one or more apparatuses to perform a method in accordance with any one of Clauses 1-18.

Clause 20: One or more apparatuses configured for wireless communications, comprising: one or more memories; and one or more processors, coupled to the one or more memories, configured to cause the one or more apparatuses to perform a method in accordance with any one of Clauses 1-18.

Clause 21: One or more apparatuses configured for wireless communications, comprising: one or more memories; and one or more processors, coupled to the one or more memories, configured to perform a method in accordance with any one of Clauses 1-18.

Clause 22: One or more apparatuses, comprising means for performing a method in accordance with any one of Clauses 1-18.

Clause 23: One or more non-transitory computer-readable media comprising executable instructions that, when executed by one or more processors of one or more apparatuses, cause the one or more apparatuses to perform a method in accordance with any one of Clauses 1-18.

Clause 24: One or more computer program products embodied on one or more computer-readable storage media comprising code for performing a method in accordance with any one of Clauses 1-18.

Clause 25: One or more apparatuses configured for wireless communications, comprising: a processing system that includes one or more processors and one or more memories coupled with the one or more processors, the processing system configured to cause the one or more apparatuses to perform a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
identify a synchronization signal block (SSB) in a first frequency bandwidth across a time domain, wherein:
the SSB occupies a first set of resources and does not occupy a second set of resources of a plurality of subcarriers spread across a frequency domain and a plurality of symbols in the time domain,
each of the plurality of symbols include at least one resource of the first set of resources, and
the first set of resources and the second set of resources form a pattern configured for detectability by a machine learning (ML) model configured to detect SSBs; and
communicate with a network entity based at least in part on the SSB.

2. The apparatus of claim 1, wherein:
the plurality of subcarriers and the plurality of symbols form a plurality of resource blocks (RBs); and
at least one RB of the plurality of RBs comprises at least one first resource of the first set of resources and at least one second resource of the second set of resources.

3. The apparatus of claim 2, wherein the at least one first resource is interlaced with the at least one second resource in the at least one RB.

4. The apparatus of claim 3, wherein the SSB comprises a primary synchronization signal (PSS) comprising the at least one RB.

5. The apparatus of claim 1, wherein the SSB comprises a physical broadcast channel (PBCH) that occupies at least two non-contiguous in frequency sets of resources of the first set of resources in a symbol of the plurality of symbols.

6. The apparatus of claim 1, wherein a transmission power of the SSB is different across the first set of resources.

7. The apparatus of claim 1, wherein the SSB comprises a physical broadcast channel (PBCH) that occupies at least a portion of each of the plurality of symbols.

8. The apparatus of claim 1, wherein the SSB comprises:
a secondary synchronization signal (SSS) that occupies a symbol of the plurality of symbols; and
a physical broadcast channel (PBCH) that does not occupy the symbol.

9. The apparatus of claim 1, wherein the second set of resources comprises five or more non-contiguous sets of resources.

10. An apparatus for wireless communications, comprising a processing system that includes one or more processors and one or more memories coupled with the one or more processors, the processing system configured to cause a network entity to:
transmit a synchronization signal block (SSB) in a first frequency bandwidth across a time domain, wherein:
the SSB occupies a first set of resources and does not occupy a second set of resources of a plurality of subcarriers spread across a frequency domain and a plurality of symbols in the time domain,
each of the plurality of symbols include at least one resource of the first set of resources, and
the first set of resources and the second set of resources form a pattern configured for detectability by a machine learning (ML) model, at a user equipment (UE), configured to detect SSBs; and
communicate with the UE based at least in part on the SSB.

11. The apparatus of claim 10, wherein:
the plurality of subcarriers and the plurality of symbols form a plurality of resource blocks (RBs); and
at least one RB of the plurality of RBs comprises at least one first resource of the first set of resources and at least one second resource of the second set of resources.

12. The apparatus of claim 11, wherein the at least one first resource is interlaced with the at least one second resource in the at least one RB.

13. The apparatus of claim 12, wherein the SSB comprises a primary synchronization signal (PSS) comprising the at least one RB.

14. The apparatus of claim 10, wherein the SSB comprises a physical broadcast channel (PBCH) that occupies at least two non-contiguous in frequency sets of resources of the first set of resources in a symbol of the plurality of symbols.

15. The apparatus of claim 10, wherein a transmission power of the SSB is varied across the first set of resources.

16. The apparatus of claim 10, wherein the SSB comprises a physical broadcast channel (PBCH) that occupies at least a portion of each of the plurality of symbols.

17. The apparatus of claim 10, wherein the SSB comprises:
a secondary synchronization signal (SSS) that occupies a symbol of the plurality of symbols; and
a physical broadcast channel (PBCH) that does not occupy the symbol.

18. The apparatus of claim 10, wherein the second set of resources comprises five or more non-contiguous sets of resources.

19. A method for wireless communications by a UE comprising:
identifying a synchronization signal block (SSB) in a first frequency bandwidth across a time domain, wherein:
the SSB occupies a first set of resources and does not occupy a second set of resources of a plurality of subcarriers spread across a frequency domain and a plurality of symbols in the time domain,
each of the plurality of symbols include at least one resource of the first set of resources, and
the first set of resources and the second set of resources form a pattern configured for detectability by a machine learning (ML) model configured to detect SSBs; and
communicating with a network entity based at least in part on the SSB.

20. The method of claim 19, wherein:
the plurality of subcarriers and the plurality of symbols form a plurality of resource blocks (RBs); and
at least one RB of the plurality of RBs comprises at least one first resource of the first set of resources and at least one second resource of the second set of resources.
